(19) United States
(12) Patent Application Publication
(10) Pub. No.: US 2018/0070364 A1
(43) Pub. Date: Mar. 8, 2018

(54) INTERFERENCE MITIGATION VIA SPACE-TIME SUBSPACE PROJECTION

(71) Applicant: QUALCOMM Incorporated, San Diego, CA (US)

(72) Inventors: Nicola Varanese, Nuremberg (DE); Louay Jalloul, San Jose, CA (US); Pierpaolo Vallese, Nuremberg (DE)

(21) Appl. No.: 15/630,040

(22) Filed: Jun. 22, 2017

Related U.S. Application Data
(60) Provisional application No. 62/384,962, filed on Sep. 8, 2016.

(51) Int. Cl. H04W 72/08; H04L 5/14; H04W 72/04; H01Q 1/52

(52) U.S. Cl. CPC H04W 72/082; H04L 5/1461; H01Q 1/521; H04W 72/046; H04W 72/0446

(57) ABSTRACT

Methods, systems, and devices for wireless communication are described. A wireless device may receive a signal using a plurality of radio frequency (RF) chains, and may digitally sample the signal over a period of time at outputs of the plurality of RF chains. The sampling may result in a plurality of sample time vectors. The device may map the digitally sampled signal to a set of one or more virtual antenna ports. The mapping may be performed for one or more observation sets of digital samples of the signal. Each observation set may represent a window of sample time vectors. The device may process a signal of interest (SoI) by processing digital samples associated with the set of one or more virtual antenna ports. The device may identify an interference channel contributing to interference of the SoI, and the mapping may be based on mitigating the interference of the SoI.

### CROSS REFERENCES

The present Application for Patent claims priority to U.S. Provisional Patent Application No. 62/384,962 by Varanese, et al., entitled “INTERFERENCE MITIGATION VIA SPACE-TIME SUBSPACE PROJECTION,” filed Sep. 8, 2016, assigned to the assignee hereof.

### BACKGROUND

The following relates generally to wireless communication and more specifically to interference mitigation via space-time subspace projection.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi network, (i.e., a network operating according to the Institute of Electrical and Electronics Engineers (IEEE) 802.11 family of standards) may include AP that may communicate with one or more stations (STAs) or wireless devices. The AP may be coupled to a packet data network, such as the Internet, and may enable a mobile device to communicate via the network (or communicate with other devices coupled to the access point). A wireless device may communicate with a network device bi-directionally. For example, in a WLAN, a wireless device may communicate with an associated AP via downlink (DL) and uplink (UL). The DL (or forward link) may refer to the communication link from the AP to the station, and the UL (or reverse link) may refer to the communication link from the station to the AP.

Some wireless devices may have two or more co-located radios for communicating using different radio access technologies (RATs). Co-location of radios using different RATs, in a wireless device such as a smartphone, may cause inter-RAT interference when the radios operate on the same, adjacent, or harmonically-linked channels. Accounting for interference at one radio due to a co-located radio may allow for more efficient processing of desired signals.

### SUMMARY

The described techniques relate to improved methods, systems, devices, or apparatuses that support interference mitigation via space-time subspace projection. A wireless device may receive a signal using a plurality of radio frequency (RF) chains, and may digitally sample the signal over a period of time at outputs of the plurality of RF chains. The sampling may result in a plurality of sample time vectors. Each sample time vector may include a plurality of digital samples corresponding to the plurality of RF chains for a sample time. The wireless device may map the digitally sampled signal to a set of one or more virtual antenna ports. The mapping may be performed for one or more observation sets of digital samples of the signal. Each observation set may represent a window of sample time vectors. The wireless device may process a signal of interest (SoI) by processing digital samples associated with the set of one or more virtual antenna ports.

A method for wireless communication is described. The method may include receiving a signal using a plurality of RF chains of a wireless device, and digitally sampling the signal over a period of time at outputs of the plurality of RF chains. The sampling may result in a plurality of sample time vectors, with each sample time vector including a plurality of digital samples corresponding to the plurality of RF chains for a sample time. The method may also include mapping the digitally sampled signal to a set of one or more virtual antenna ports. The mapping may be performed for one or more observation sets of digital samples of the signal. Each observation set may represent a window of sample time vectors. The method may further include processing an SoI by processing digital samples associated with the set of one or more virtual antenna ports. The method may also include identifying an interference channel contributing to interference of the SoI. The mapping may be based at least in part on mitigating the interference of the SoI.

An apparatus for wireless communication is described. The apparatus may include means for receiving a signal using a plurality of RF chains of a wireless device, and means for digitally sampling the signal over a period of time at outputs of the plurality of RF chains. The sampling may result in a plurality of sample time vectors, with each sample time vector including a plurality of digital samples corresponding to the plurality of RF chains for a sample time. The apparatus may also include means for mapping the digitally sampled signal to a set of one or more virtual antenna ports. The mapping may be performed for one or more observation sets of digital samples of the signal. Each observation set may represent a window of sample time vectors. The apparatus may further include means for processing an SoI by processing digital samples associated with the set of one or more virtual antenna ports. The apparatus may also include means for identifying the SoI and means for identifying an interference channel contributing to interference of the SoI. The mapping may be based at least in part on mitigating the interference of the SoI.

An apparatus for wireless communication in a system is described. The apparatus may include a processor, memory in electronic communication with the processor, and instructions stored in the memory. The instructions may be operable, when executed by the processor, to cause the apparatus to receive a signal using a plurality of RF chains of a wireless device, and to digitally sample the signal over a period of time at outputs of the plurality of RF chains. The sampling may result in a plurality of sample time vectors, with each sample time vector including a plurality of digital samples corresponding to the plurality of RF chains for a sample time. The instructions may also be executable by the processor to cause the apparatus to map the digitally sampled signal to a set of one or more virtual antenna ports. The mapping may be performed for one or more observation sets of digital samples of the signal. Each observation set may represent a window of sample time vectors. The instructions may be further executable by the processor to cause the apparatus to process an SoI by processing digital samples associated with the set of one or more virtual antenna ports. The instructions may also be executable by the processor to cause the apparatus to identify the SoI and to identify an interference channel contributing to interference of the SoI. The mapping may be based at least in part on mitigating the interference of the SoI.

A non-transitory computer readable medium storing code for wireless communication is described. The code may include instructions executable by a processor to receive a signal using a plurality of RF chains of a wireless device, and to digitally sample the signal over a period of time at outputs of the plurality of RF chains. The sampling may result in a plurality of sample time vectors, with each sample time vector including a plurality of digital samples corresponding to the plurality of RF chains for a sample time. The instructions may also be executable by the processor to map the digitally sampled signal to a set of one or more virtual antenna ports. The mapping may be performed for one or more observation sets of digital samples of the signal. Each observation set may represent a window of sample time vectors. The instructions may be further executable by the processor to process an SoI by processing digital samples associated with the set of one or more virtual antenna ports. The instructions may also be executable by the processor to cause the apparatus to identify the SoI and to identify an interference channel contributing to interference of the SoI. The mapping may be based at least in part on mitigating the interference of the SoI.

Some examples of the method, apparatus, and non-transitory computer-readable medium described above may further include processes, features, means, or instructions for transmitting at least one signal using at least one RF chain of the wireless device. In these examples, the interference channel may be associated with the transmission of the at least one signal.

In some examples of the method, apparatus, and non-transitory computer-readable medium described above, the received signal may be received according to a first RAT, and at least one transmitted signal may be transmitted according to a second RAT.

In some examples of the method, apparatus, and non-transitory computer-readable medium described above, the interference channel may be based at least in part on: interference associated with at least one of duplexer and tuner impedance mismatch of the RF chains, non-linearity of transfer functions of power amplifiers in the RF chains, limited RF isolation between different RF chains, limited isolation between physical antennas associated with different RF chains, or a combination thereof.

Some examples of the method, apparatus, and non-transitory computer-readable medium described above may further include processes, features, means, or instructions for determining a space-time covariance matrix for reception of the signal using the plurality of RF chains, and determining a mapping matrix based at least in part on an eigenvalue decomposition (EVD) of the space-time covariance matrix. In these examples, the mapping may be based at least in part on the mapping matrix.

Some examples of the method, apparatus, and non-transitory computer-readable medium described above may further include processes, features, means, or instructions for computing values of the mapping matrix based at least in part on a set of smallest eigenvalues of the EVD. In these examples, the mapping may be based at least in part on the computed values of the mapping matrix.

Some examples of the method, apparatus, and non-transitory computer-readable medium described above may further include processes, features, means, or instructions for computing values of the mapping matrix based at least in part on the interference channel using a Gram-Schmidt orthonormalization procedure.

In some examples of the method, apparatus, and non-transitory computer-readable medium described above, the mapping may include performing, for each observation set of digital samples of the signal, a linear convolution of the mapping matrix with the observation set.

In some examples of the method, apparatus, and non-transitory computer-readable medium described above, the mapping may include setting, based at least in part on the mapping matrix, filter coefficients for a set of multi-tap digital filters; processing each observation set of digital samples of the signal through the set of multi-tap digital filters; and generating a set of digital samples for each of the one or more virtual antenna ports by summing, for each of the one or more virtual antenna ports, a set of outputs of a subset of the set of multi-tap digital filters.

Some examples of the method, apparatus, and non-transitory computer-readable medium described above may further include processes, features, means, or instructions for adjusting the space-time covariance matrix for the signal, before determining the mapping matrix, by pre-multiplying the space-time covariance matrix by a square root matrix of a noise space-time covariance matrix for reception of the signal using the plurality of RF chains, to produce a product, and by post-multiplying the product by a Hermitian transpose of the square root matrix.

Some examples of the method, apparatus, and non-transitory computer-readable medium described above may further include processes, features, means, or instructions for adjusting the space-time covariance matrix for the signal, before determining the mapping matrix, by subtracting a noise space-time covariance matrix for reception of the signal using the plurality of RF chains from the space-time covariance matrix.

In some examples of the method, apparatus, and non-transitory computer-readable medium described above, the space-time covariance matrix may be determined during periods of idle mode reception at the wireless device.

Some examples of the method, apparatus, and non-transitory computer-readable medium described above may further include processes, features, means, or instructions for determining a channel matrix for data demodulation during a channel estimation procedure interval, in which the channel matrix for data demodulation is based at least in part on the mapping matrix.

In some examples of the method, apparatus, and non-transitory computer-readable medium described above, the set of one or more virtual antenna ports differs in number from a number of RF chains in the plurality of RF chains.

### BRIEF DESCRIPTION OF THE DRAWINGS

FIG. 1 illustrates an example of a system for wireless communication that supports interference mitigation with space or space-time subspace projection in accordance with aspects of the present disclosure.

FIG. 2 illustrates an example of a WLAN that supports interference mitigation via space or space-time subspace projection in accordance with aspects of the present disclosure.

FIG. 3 illustrates an example of a wireless device that supports interference mitigation via space or space-time subspace projection in accordance with aspects of the present disclosure.

FIG. 4 illustrates an application of space-time non-linear interference mitigation (ST-NLIM) to a signal received at a wireless device in accordance with aspects of the present disclosure.

FIG. 5 illustrates another application of ST-NLIM to a signal received at a wireless device in accordance with aspects of the present disclosure.

FIG. 6 illustrates an example of a processing timeline that supports interference mitigation via space or space-time subspace projection in accordance with aspects of the present disclosure.

FIG. 7 illustrates an example of a processing timeline that supports interference mitigation via space or space-time subspace projection in accordance with aspects of the present disclosure.

FIG. 8 illustrates an example of a process flow that supports interference mitigation via space-time subspace projection in accordance with aspects of the present disclosure.

FIGS. 9 through 11 show block diagrams of a device or devices that support interference mitigation via space-time subspace projection in accordance with aspects of the present disclosure.

FIG. 12 illustrates a block diagram of a system including a wireless device that supports interference mitigation via space-time subspace projection in accordance with aspects of the present disclosure.

FIGS. 13 through 15 illustrate methods for interference mitigation via space-time subspace projection in accordance with aspects of the present disclosure.

### DETAILED DESCRIPTION

Spatial processing may be employed within a wireless device that has two or more co-located radios for communicating using different RATs. This may increase the efficiency with which such devices process desired signals.

By way of example, a transmission on one radio may interfere with a reception on another radio. Due to their proximity, a regular transmission on one radio employing one RAT may cause corrupted reception at another radio employing the other RAT. For example, co-located Long Term Evolution (LTE) radio and WLAN radio can interfere with each other when they operate on adjacent channels in the 2.4 GHz band (e.g., channel 1 of WLAN and band 40 of time-division LTE (TD-LTE)). STAs or user equipment (UEs) utilizing current co-located RAT interference countermeasures may experience significant communication degradation (e.g., harmonic distortion). Desense (e.g., degradation in receiver sensitivity due to same device noise sources) may be hard to predict as it may depend on the choice of device components and the physical original equipment manufacturer (OEM) board layout. Improved methods to reduce self-interference generated by concurrent usage of multiple RATs on the same device may thus increase system performance in such scenarios.

Current filters and counter measures may be costly and increase bill of materials (BOM) of producing such devices. Further, current interference mitigation techniques may be ineffective in scenarios where the interference to noise ratio is high or for interference such as harmonic distortion due to the inability to induce such interference. Additional counter measures may be necessary to avoid such scenarios, which may be associated with system degradation. So a new digital non-linear interference mitigation (NLIM) process, as described herein, may use spatial processing for subspace based interference mitigation.

The NLIM process may include techniques related to null space linear interference mitigation. A desired signal, which may be referred to as a signal of interest (SoI), may correspond to a subset of a total number of physical chains a device is capable of utilizing (e.g., radio frequency (RF) chains dedicated to reception over a particular RAT). To mitigate interference on the SoI, the SoI subset of chains and additional Rx chains may be mapped to virtual antennas for processing of spatial streams corresponding to the SoI. In some examples, the mapping may have a time component and be based on a space-time spatial projection. Time domain samples of a signal received over all physical chains may be utilized to estimate a vector subspace associated with interference on the signal (e.g., using vectors representing interference across each of the physical chains).

As described herein, the NLIM process may then determine a mapping matrix that lies in a vector subspace that is orthogonal to the subspace estimated to be associated with interference across the physical chains (e.g., by constructing the mapping matrix with columns that are orthogonal to estimated interference vectors). The mapping matrix may then be applied to the signal to produce a mapped signal or virtual antennas (e.g., spatial streams) with orthogonal interference components canceling out, and the wireless device may process the mapped signal, thus mitigating interference of the original SoI.

Aspects of the disclosure introduced above are described more fully below in the context of a wireless communications system. Examples of wireless systems supporting subspace-based interference mitigation (e.g., space or space-time subspace-based interference mitigation) in addition to example front end interference and processing timelines are then described. Aspects of the disclosure are further illustrated by and described with reference to apparatus diagrams, system diagrams, and flowcharts that relate to interference mitigation with subspace projection.

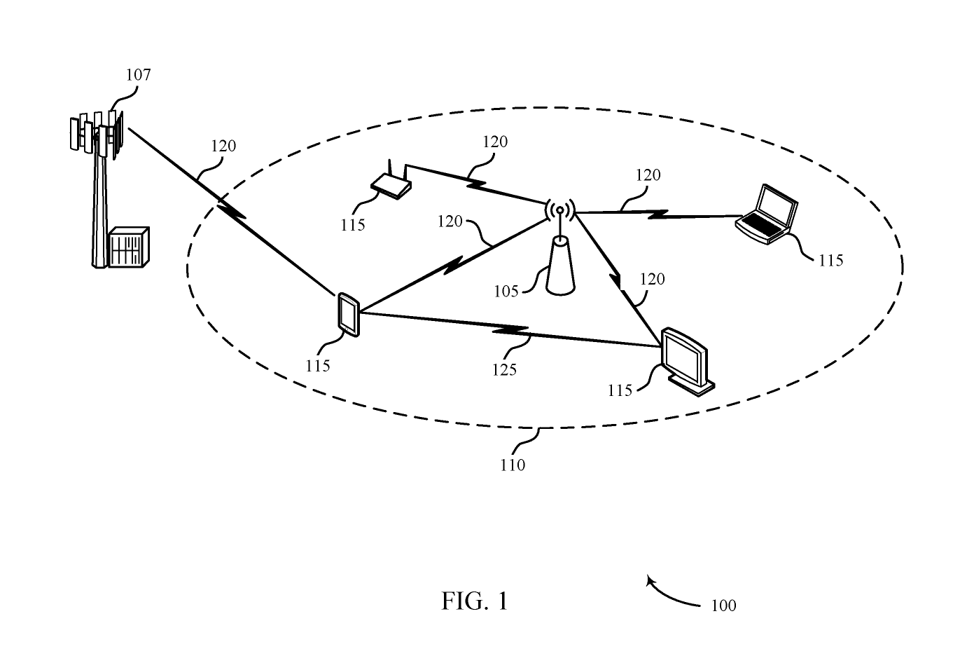

FIG. 1 illustrates a WLAN 100 (also known as a Wi-Fi network) configured in accordance with various aspects of the present disclosure. The WLAN 100 may include an AP 105 and multiple associated wireless devices 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated wireless devices 115 may represent a basic service set (BSS) or an extended service set (ESS). The various wireless devices 115 in the network are able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS.

In some cases, a wireless device 115 may be used interchangeably with a wireless station or user equipment. Wireless device 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless device 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of things (IoT) device, an Internet of Everything (IoE) device, a machine type communication (MTC) device, an appliance, an automobile, or the like.

Although not shown in FIG. 1, a wireless device 115 may be located in the intersection of more than one coverage area 110 and may associate with more than one AP 105. A single AP 105 and an associated set of wireless devices 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two wireless devices 115 may also communicate directly via a direct wireless link 125 regardless of whether both wireless devices 115 are in the same coverage area 110. Examples of direct wireless links 120 may include Wi-Fi Direct connections, Wi-Fi Tunneled Direct Link Setup (TDLS) links, and other group connections. Wireless devices 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

A wireless device 115 of WLAN 100 may include co-located radios which may additionally support communications with other networks operating using different RATs. For example, a wireless device 115 may communicate with a base station 107 (e.g., an LTE base station) in addition to AP 105. Wireless device 115 communications with AP 105 and base station 107 may utilize different RATs and may occur simultaneously or in a time division duplexing (TDD)-like scheme. In some cases, a base station 107 and a wireless device 115 may communicate using more than one carrier. Each aggregated carrier is referred to as a component carrier (CC). Each component can have a bandwidth of, e.g., 1.4, 3, 5, 10, 15 or 20 MHz. In some cases, the number of CCs can be limited to, e.g., a maximum of five 20 MHz carriers, giving maximum aggregated bandwidth is 100 MHz. In frequency division duplexing (FDD), the number of aggregated carriers can be different in DL and UL. The number of UL component carriers may be equal to or lower than the number of DL component carriers. The individual component carriers can also be of different bandwidths. For TDD, the number of CCs as well as the bandwidths of each CC will normally be the same for DL and UL. Component carriers may be arranged in a number of ways. For example, a carrier aggregation (CA) configuration may be based on contiguous component carriers within the same operating frequency band, i.e., called intra-band contiguous CA. Non-contiguous allocations can also be used, where the component carriers may be either be intra-band, or inter-band.

A wireless device 115 may have hardware supporting more than one RAT to facilitate the communications with both the AP 105 and base station 107. For example, radios, antennas, transceivers, or the like, supporting different RATs may be co-located on a wireless device 115. In scenarios where wireless device 115 communicates using two different RATs at roughly the same time, communications on one RAT may cause interference with the communications on the other RAT (e.g., a transmitter associated with one RAT interferes with the reception of communications of a second RAT). For example, the wireless device 115 may communicate with a base station 107 over an LTE network while communicating with the AP 105 over WLAN.

There may be multiple sources of interference in systems supporting concurrent use of multiple RATs (e.g., WLAN 100). The transmitted signal associated with a RAT may leak into the reception bandwidth of another RAT through several mechanisms due to the non-linearity of the radio frequency (RF) front end of wireless device 115. For example, spurious interfering signals may be generated in a zero intermediate frequency (ZIF) architecture due to non-linear RF/Analog component behavior at the transmitter.

Wireless devices 115 that support multiple RATs may also be prone to issues from harmonic distortion. Harmonic distortion may refer to the non-linearity of the front end due to harmonic components of transmitted waveforms falling within the band a receiving radio is operating within (e.g., a reception band). Harmonics of a local oscillator (LO) used for up conversion may create transmission signal components within the reception band of the different RAT. For example, the receiver may demodulate RF signals centered around integer multiples of a carrier frequency used for transmission by another RAT. Inter-modulation distortion (IMD) may occur where modulation of a transmitted waveform generates interference within the band of the receiving technology.

Non-linear operations of two or more transmitters may result in IMD, which can cause sensitivity loss in a receiver located on the same device. For example, simultaneous operation of a WLAN transmitter in a 2.4 GHz band and a wireless wide area network (WWAN) transmitter in the 800 MHz band can result in a second order IMD component (IMD2) that falls into the receive band of a global positioning system (GPS) receiver (e.g., 2.4 GHz−800 MHz*1.6 GHz), thereby resulting in sensitivity loss in the GPS receiver. Interference may also arise due to adjacent channel leakage (ACLR) from neighboring or adjacent bands. For example, in 2.4 GHz Wi-Fi operation there may be interference due to nearby adjacent LTE band transmissions (e.g., B40, B41, B7, B38).

Countermeasures to reduce interference may include RF filters, analog interference cancelation, coexistence management, and algorithms for interference cancellation. However, additional RF filters may be costly and increase BOM of producing such devices by original equipment manufacturers. Further, additional costly filters may increase overall insertion loss (e.g., by 2-3 dB) for the aggressor RAT (e.g., transmitting RAT interfering with a victim RAT associated with a co-located receiver), thus increasing power amplifier power consumption. Analog interference cancelation (e.g., subtracting an interference signal from a received signal in the analog domain prior to the analog to digital converter) may also increase BOM and the noise figure (NF) (e.g., from staying in the analog RF domain), and may further result in routing problems on the printed circuit board (PCB).

In the digital domain, a coexistence (COEX) manager may reduce aggressor power, and prevent transmission on a RAT during reception of the victim RAT (e.g., time division multiplexing (TDM) operation over the different RATs). This may be referred to as RAT prioritization, and may reduce system throughput. Various techniques (e.g., digital domain interference techniques) may be applied in scenarios where the aggressor signal is within the dynamic range of the receiver. Such processes or algorithms may exploit the fact that the interference comes from another radio on the same chip, thus transmission knowledge (e.g., digital domain transmission samples) may be used to help cancel interference experienced at the receiver of another RAT.

Non-linear operations of two or more transmitters may further result in IMD, which can cause sensitivity loss in a receiver located on the same device. For example, simultaneous operation of a WLAN transmitter in the 2.4 GHz band and a WWAN transmitter in the 800 MHz band can result in an IMD2 that falls into the receive band of a GPS receiver (e.g., 2.4 GHz−800 MHz*1.6 GHz), thereby resulting in sensitivity loss in the GPS receiver. Similarly, simultaneous operation of a WLAN transmitter in a 5.660 GHz channel and a WWAN transmitter in a 1860 MHz channel can result in a third order IMD component (IMD3) that falls into a 1940 MHz receive channel of a WWAN receiver (e.g., 5660 MHz−2×1860 MHz=1940 MHz), thereby resulting in sensitivity loss in the WWAN receiver. A filter for removing IMD components may be provided at the input of the affected receiver (e.g., the victim receiver). Adequate filters may be costly and increase BOM of producing such devices. For example, Table 1 shows example coupling mechanisms (e.g., interference) and scenarios.

TABLE 1

| Mechanism | Sub-type | Aggressor Bands | Victim Bands |
|---|---|---|---|
| Harmonic | RF/Analog | B1, B2, B3, B4, | WLAN 5 GHz |
| | non-linearity | B9, B10, B24, B25 | |
| | LO | WLAN 5 GHz | B2, B3, B9, B25 |
| | Harmonics | | |
| ACLR | — | B40, B7, B41 | WLAN 2.4 GHz |
| | | WLAN 2.4 GHz | B40, B7, B41 |
| IMD | — | WLAN 2.4 and 5G | B7, B25, B4, B3, |
| | | | B2, B18, B20 |

Various techniques may further be used to mitigate same device interference using, for example, knowledge of transmission information. For example, non-linear interference cancelation (NLIC) is a digital baseband algorithm that may cancel interference caused by transmitted signals and spurs of diverse nature (e.g., harmonic distortion, IMD, etc.). However, adoption of certain technologies (e.g., WLAN) in co-located RAT devices may introduce additional complexities not adequately addressed by NLIC-like methods, specifically in ACLR scenarios.

For example, in a WLAN reception case (e.g., Wi-Fi is victim), additional architectural complexities may arise from the need to route samples from one modem to another. Further, additional algorithmic complexity may result from unfeasibility to fit into WLAN receiver timelines. Coexistence techniques utilizing transmission power backoff and inter-RAT time division multiplexing may thus be used to avoid such issues (e.g., via use of a coexistence manager) but may be associated with decreased system throughput.

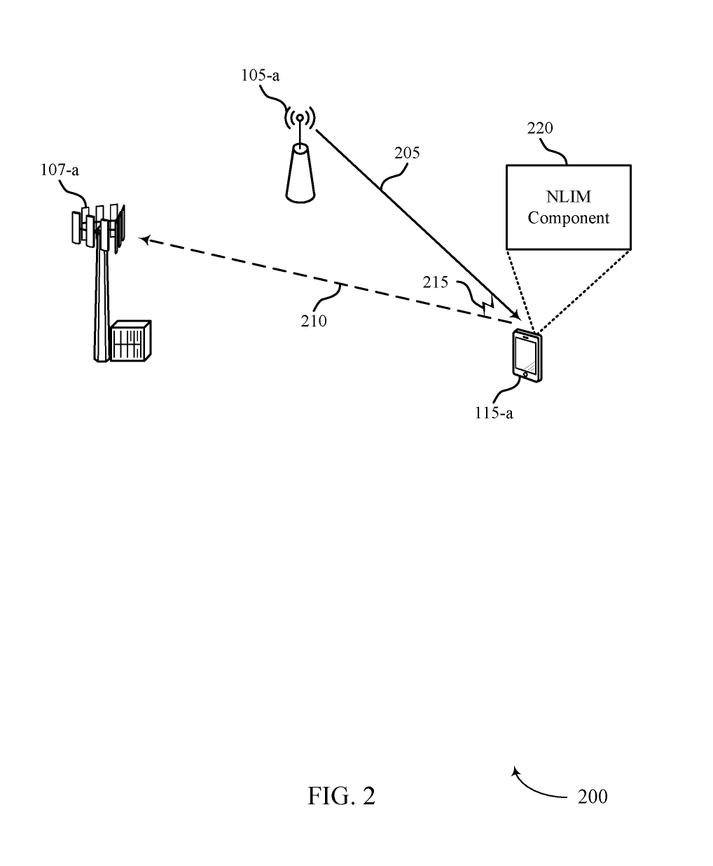

FIG. 2 illustrates an example of a wireless communications system 200 for interference mitigation with subspace projection. Wireless communications system 200 may include wireless device 115-a implementing new digital NLIM techniques (e.g., algorithms) utilizing spatial processing for subspace based interference mitigation. In the present example, wireless device 115-a may transmit communications over uplink 210 to base station 107-a in addition to receiving communications over downlink 205 from AP 105-a. Thus, communications over uplink 210 and downlink 205 may occur via co-located receivers operating with different RATs (e.g., LTE and Wi-Fi). Interference 215 associated with co-located and multiple RAT receiver operation may be mitigated with use of NLIM component 220 of wireless device 115-a. NLIM component 220 may perform aspects of functions relating to NLIM techniques described herein.

An SoI may correspond to spatial streams associated with a subset of a total number of physical chains a device is capable of utilizing (e.g., chains dedicated to reception over downlink 205 associated with AP 105-a). Time domain samples of a signal received over all physical chains may be utilized to estimate a vector subspace associated with interference on the signal (e.g., using vectors representing interference across each of the physical chains). NLIM techniques may then determine a mapping matrix that lies in a vector subspace that is orthogonal to the subspace estimated to be associated with interference across the physical chains (e.g., by constructing the mapping matrix with columns that are orthogonal to estimated interference vectors). The mapping matrix may then be applied to the signal to produce a mapped signal with orthogonal interference components canceling out, thus mitigating interference of the original SoI. In some examples, a coexistence manager may manage NLIM and may identify available Rx chains, desired spatial streams for reception, and other factors to implement NLIM techniques.

NLIM mapping may improve system performance with respect to, for example, packet detection, gain control, bit error rate (BER), or the like. Specifically, the NLIM mapping in the RxTD control path may serve the purpose of improving packet detection and gain control (e.g., signal sizing) in the presence of the aggressor signal (e.g., on-device transmitting signal). The RxTD control path may also account for initial time/frequency recover, which may influence the decoding performance of control fields in the non-beamformed part of the frame. NLIM methods may significantly improve such processes. Additionally, NLIM mapping in the data path may improve BER performance. The NLIM mapping may be performed in RxFD depending on the demodulation load (e.g., arising from shared hardware across the multiple RATs) for the specific concurrency scenario. In the frequency domain, different NLIM mappings may be used for each subcarrier or group of subcarriers, thus addressing multipath components of the same aggressor signal. Frequency domain approaches may be applied in scenarios where additional RF chains on wireless device 115-a are unavailable. In such scenarios RxFD may sustain the load, and minimum mean square error (MMSE) beamforming (e.g., interference nulling) may be implemented.

Two or more physical chains may be mapped to at least one virtual antenna for frequency domain processing of an associated spatial stream to be received. For example, a four-physical chain signal may be mapped (e.g., via a spatial mapping matrix) to two virtual antennas, an effective channel may then be extracted from the mapped signal for data demodulation in the frequency domain.

The spatial mapping matrix may be obtained by solving for the eigenvalue decomposition (EVD) of a spatial covariance matrix (e.g., using the second order statistics of the interference to calculate an effective interference vector). The spatial covariance matrix may be obtained during, for example, inter-packet gaps (e.g., short interframe space (SIFS)) where the SoI is not present. That is, estimates of the spatial covariance matrix may be computed when the receiving chain is idle (e.g., when wireless device 115-a is not receiving packets over downlink 205 from AP 105-a) and updated in the order of, for example, tens or hundreds of milliseconds. The interference plus noise covariance matrix may be computed for each subcarrier or group of subcarriers. In some cases, this procedure may be associated with spectral scanning. During the inter-packet gap, the covariance of interference and noise may be estimated directly from the received time domain samples. Effective interference vectors may thus be obtained from the spatial covariance matrix and used to determine the column vectors of the spatial mapping matrix.

As discussed above, the spatial mapping matrix may then be obtained as a sub-matrix of the EVD of the spatial covariance matrix. The column vectors of the spatial whitening matrix may be the eigenvectors corresponding to the smallest eigenvalues (e.g., to represent the subspace where interference is weaker). In some cases, the EVD may be computed by re-using the singular value decomposition (SVD) of the shared firmware (FW) or processor of the wireless device 115-a. Therefore, the columns of the spatial mapping matrix may be orthonormal vectors which are also orthogonal to the interference vector(s). Consequently, if an interference vector (e.g., associated with interference 215) is known prior to analysis of the spatial covariance matrix, the columns of the spatial mapping matrix may be computed via a Gram-Schmidt orthonormalization procedure.

Interference vectors may also be estimated using non-linear interference cancelation or other digital domain techniques. Alternatively, different signal to interference noise ratio (SINR) maximization criteria may be chosen to calculate a spatial mapping matrix based on a different eigenvalue problem (e.g., a MMSE-like solution). These alternative methods may apply to scenarios where the SoI channel matrix is known.

The effective channel matrix used for data demodulation may be estimated during channel estimation procedure intervals (e.g., occurring every 100 ms) resulting in interference alignment where a transmitter may concentrate the energy of the SoI in the subspace orthogonal to the interferer.

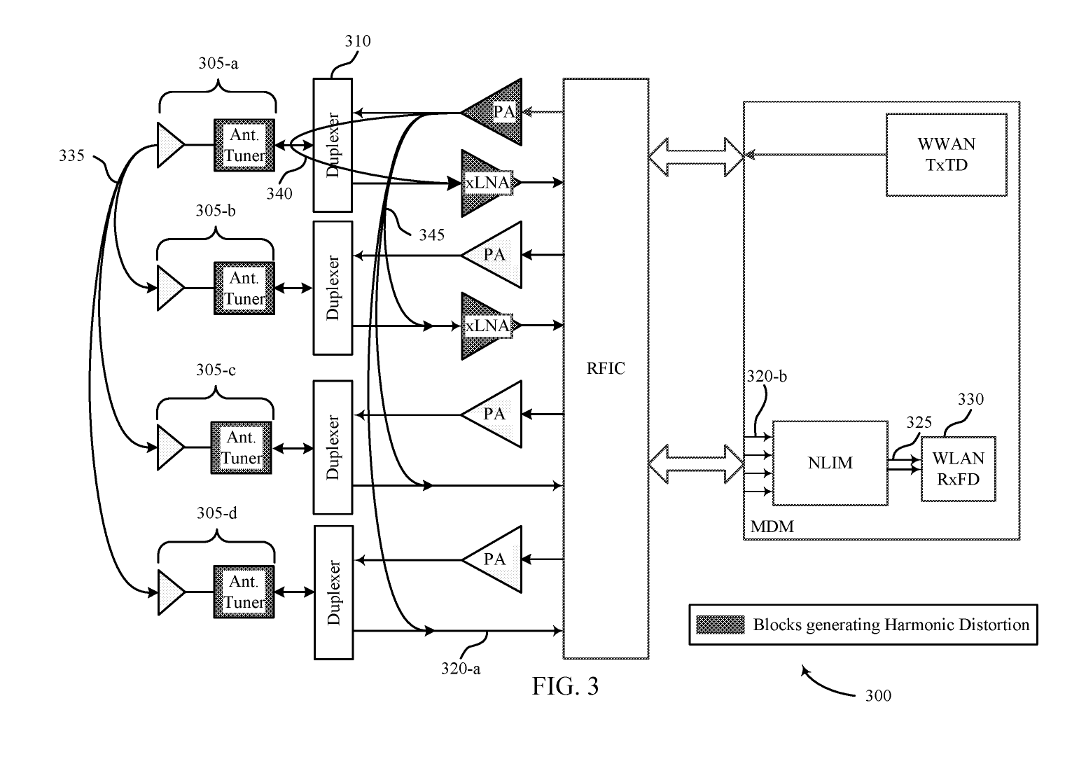

FIG. 3 illustrates an example of a wireless device 300 that supports interference mitigation via space or space-time subspace projection. The present example shows wireless device 300 transmitting LTE communications while simultaneously receiving Wi-Fi communications. Antenna 305-a may be shared between LTE transmissions and Wi-Fi receptions, while antenna 305-b, antenna 305-c, and antenna 305-d may be devoted to Wi-Fi reception. In this case, signal transmissions from antenna 305-a may leak into the other receive chains used for Wi-Fi reception. Physical chains associated with reception of the signal intended to be received (e.g., chains associated with four spatial streams 320-b) may undergo NLIM techniques to produce two virtual antennas 325 for processing at the WLAN 330. In some cases, when the radio frequency integrated chip (RFIC) block comprises one or more sub blocks, one or more spatial streams may be combined with borrowed chains (not shown) that undergo NLIM techniques to produce two virtual antennas. The present example and discussion depicts a single example. Wireless devices 115 implementing alternate RATs such as Bluetooth, GPS, or the like, in addition to wireless devices 115 with different front end configurations of antennas and RF chains, may utilize described techniques by analogy.

In the example of FIG. 3, a signal model for 4 Rx antennas, 2 spatial stream WLAN configuration (e.g., spatial streams 320-a), and a single-antenna interferer (e.g., antenna 305-a) where k is the sample index, may be modeled as,

y[k]=Hs[k]+h_{I}x[k]+n[k] (1)

where y[k] is a 4×1 Rx signal matrix corresponding to the signal received at all 4 antennas 305. H is a 4×2 SoI channel matrix that may comprise precoding or precoding processing from the transmission scheme (e.g., AP 105 transmission precoding), s[k] is a 2×1 SoI matrix (e.g., corresponding to the two spatial streams 320-a), h_{I} is a 4×1 interference channel matrix, x[k] is a 1×1 interference scalar, and n[k] is a 4×1 noise matrix (e.g., from thermal noise), all on a per k sample basis.

Applying NLIM operation or mapping on Equation 1 includes introducing a 2×4 mapping matrix to map the 4 physical antennas to 2 virtual antennas 325. Thus, the mapped signal may be modeled as,

\tilde{y}[k]=W^{H}y[k]=W^{H}Hs[k]+W^{H}h_{I}x[k]+W^{H}n[k] (2)

where \tilde{y}[k] is a 2×1 mapped signal matrix that represents the two virtual antennas 325, W^{H} is the 2×4 mapping matrix, W^{H}H is a 2×2 effective channel matrix (e.g., used for data demodulation) and W^{H}h_{I}x[k] is the effective interference. That is, a mapping matrix W^{H} may be applied to a signal received over 3 or more physical chains (e.g., Equation 1) to obtain a virtual signal or spatial streams associated with virtual antennas (e.g., Equation 2). In addition to processing the mapped signal, the effective channel may be used for data demodulation in the frequency domain. The interference channel matrix, h_{I}, may not be known in general. As discussed above, potential contributing factors to such interference may include limited antenna isolation interference 335, duplexer/tuner impedance mismatch interference 340 (e.g., from power amplifier and low noise amplifier interactions with duplexers 310), and/or board coupling interference 345.

Second order statistics of the interference (e.g., a spatial covariance matrix) may be used to determine h_{I}. For example, in the context of Wi-Fi, it may be possible to exploit inter-packet gaps (e.g., SIFS) or idle periods when a device is not actively receiving a packet (e.g., the SoI is not present, aside from blockers). It may be possible to associate this procedure with spectral scanning. During SIFS, the covariance of interference and noise may be estimated directly form the received time domain samples. For example, the covariance of interference and noise may be represented as,

$${C}_{II} = \frac{1}{N} {\sum }_{k = 0}^{N - 1} y [ k ] {y}^{H} [ k ] \approx {h}_{I} {h}_{I}^{H} + {σ}^{2} I \qquad ( 3 )$$

y^{H}[k] and h_{I}^{H} may respectively refer to the Hermitian conjugate or the Hermitian transpose of the signal matrix y[k] and the interference channel matrix h_{I}. The covariance of interference and noise matrix C_{II}, may be computed within the SIFS. And the processes may be updated for each new computation of C_{II}.

The estimated covariance matrix, C_{II}, may be used to determine the mapping matrix W^{H}. The spatial mapping matrix W may be partitioned in to column vectors corresponding to the number of spatial streams (e.g., for two spatial streams W=[w₁ w₂]). W may be selected to minimize interference to noise ratio (INR) post-mitigation. That is,

$${min}_{W} \frac{tr ( {W}^{H} {C}_{II} W )}{{σ}_{n}^{2} \cdot tr ( {W}^{H} W )} = \frac{{w}_{1}^{H} {C}_{II} {w}_{1} + {w}_{2}^{H} {C}_{II} {w}_{2}}{{σ}_{n}^{2} \cdot ( {w}_{1}^{H} {w}_{1} + {w}_{2}^{H} {w}_{2} )} \qquad ( 4 )$$

where, tr( ) refers to the trace of the enclosed matrix and W is selected to minimize the ratio of Equation 4. Minimizing Equation 4 may be solved as an eigenvalue problem. W may be obtained as a 4×2 sub-matrix of the EVD of C_{II}. For example, the columns w₁ and w₂ may be the two eigenvectors corresponding to the smallest eigenvalues of the EVD (e.g., eigenvectors supporting or spanning the subspace where interference is weaker). In some cases, the EVD may be computed by reusing the SVD shared FW. Therefore, the columns w₁ and w₂ may be orthogonal to the interference and effectively null out the interference.

In low-rank interference scenarios (e.g., a single interferer, or rank one, with four receiving antennas) the matrix C_{II} may imply which subspace is orthogonal to the interference. For example, w₁ and w₂ may be determined such that they are orthogonal to the interference and when the matrix W is applied to the received signal y[k] the interference is nulled out. That is, for a single interferer model, the columns of W are orthonormal vectors which may also be orthogonal to h_{I}. For example, w₁^{H}h_{I}=0 and w₂^{H}h_{I}=0. If h_{I} is known, w₁ and w₂ may be computed via a Gram-Schmidt orthonormalization procedure. In some cases, h_{I} may be estimated using NLIC. NLIM may be tightly integrated with NLIC.

In some cases, criteria to maximize a SINR may be chosen, thereby yielding a MMSE-like solution. In such cases, the Eigenvalue problem may differ and some knowledge of the SoI channel, H, may be used. Such cases may be applied to frequency domain solutions as H is estimated in the frequency domain.

The number of Rx antennas may limit the number of spatial streams that can be received in addition to the robustness of the techniques against multiple coupling paths. For example, Table 2 shows example combinations of aggressor antennas and available Rx antennas to illustrate the potential spatial stream (SS) processing capabilities of NLIM in different scenarios.

TABLE 2

| | 1 WLAN | 2 WLAN | 2 + 1 | 2 + 2 |
|---|---|---|---|---|
| | Rx | Rx | WLAN Rx | WLAN Rx |
| 1 Aggressor | | 1 SS | 2 SS | 3 SS |
| (e.g., 1 Tx WWAN | | | | |
| UL) | | | | |
| 2 Aggressors | | | 1 SS | 2 SS |
| (e.g., 2 Tx | | | | |
| MU-MIMO | | | | |
| WWAN UL) | | | | |

However, NLIM may still be applicable in scenarios where additional Rx antennas are not available. Blank elements in Table 2 may refer to these situations where spatial processing may not be possible. In such scenarios, the data path NLIM mapping may be performed in the frequency domain and may be frequency-dependent. The interference covariance matrix may thus be computed for each subcarrier or group of subcarriers as shown in Equation 5.

$${C}_{II} ( f ) = \frac{1}{N} {\sum }_{n = 0}^{N - 1} Y [ f , n ] {Y}^{H} [ f , n ] \approx {H}_{I} ( f ) {H}_{I}^{H} ( f ) + {σ}^{2} I \qquad ( 5 )$$

NLIM may provide an approximation of the spatial whitening matrix for large INR. Considering the interference covariance matrix,

C_{II}=I+INR·h_{I}h_{I}^{H} (6)

the inverse may be written as

$${C}_{II}^{- 1} = I - \frac{INR}{1 + INR} {h}_{I} {h}_{I}^{H} = [ {u}_{h} {U}_{h} ] [ \begin{matrix}1 - \frac{INR}{1 + INR} & 0 \\ 0 & diag ( 1 )\end{matrix} ] [ \begin{matrix}{u}_{h}^{H} \\ {U}_{h}^{H}\end{matrix} ] \qquad ( 7 )$$

From equation 7, it can be realized that for large INR the whitening matrix (e.g., the square root of the inverse of C_{II}) may be approximated as,

$${C}_{II}^{- 1 / 2} \approx [ \begin{matrix}0 \\ {U}_{h}^{H}\end{matrix} ] \qquad ( 8 )$$

which is the NLIM mapping. This property may also hold in scenarios where the interference rank is larger than 1.

In some scenarios, the interference channel (e.g., the interference channel matrix h_{I}) may involve multiple coupling paths, but the number of Rx antennas (or Rx chains or RF chains) available for NLIM may be fewer than the number of Rx antennas needed for NLIM. For example, the interference channel may involve two coupling paths, but only one Rx antenna may available for applying NLIM (and one Rx antenna may not be used to mitigate interference from more than one coupling path). In these scenarios (and other scenarios), NLIM may be applied in both the space and time domain as ST-NLIM.

For an interference channel involving two coupling paths, the interference channel matrix h_{I} may be represented in the Z-domain as

h_{I}(z)=h₀+h_{d}z^{-d} (9)

where h₀ and h_{d} are independent interference channel matrices. For simplicity in describing one example, assume that h₀, h_{d}εR^{N}. If N=2, it is not possible to find a vector which is orthogonal to both h₀ and h_{d}. However, an orthogonal vector may be constructed in the Z-domain as

$${h}_{I}^{⊥} ( z ) = {h}_{0}^{⊥} - {h}_{d}^{⊥} {z}^{- d} , {h}_{0}^{⊥} = \frac{{u}_{0}^{⊥}}{‖ {h}_{d} ‖} , {h}_{d}^{⊥} = \frac{{u}_{0}^{⊥}}{‖ {h}_{0} ‖} . \qquad ( 10 )$$

In fact,

(h_{I}^{⊥}(z))^{T}·h_{I}(z)=h₀^{⊥}h₀+h_{d}^{⊥}h_{d}z^{-2d}+(h₀^{⊥}h_{d}−h_{d}^{⊥}h₀)z^{-d}=0. (11)

Assuming d=1, then the orthogonal mapping is

h_{I}^{⊥}(z)=h₀^{⊥}−h₁^{⊥}z⁻¹. (12)

If a block matrix, H, is defined as

$$H = [ \begin{matrix}{h}_{0} & {h}_{1} & 0 \\ 0 & {h}_{0} & {h}_{1}\end{matrix} ] {z}^{- d} , \qquad ( 13 )$$

an orthogonal filter can be equivalently derived as

$${( {h}_{I}^{⊥} )}^{T} H = 0 \\ {h}_{I}^{⊥} = [ \begin{matrix}{h}_{0}^{⊥} \\ - {h}_{1}^{⊥}\end{matrix} ] . \qquad ( 14 )$$

In general, h_{I}^{⊥} needs to lie in the Null Space of the matrix:

$${HH}^{T} = [ \begin{matrix}{h}_{0} {h}_{0}^{T} + {h}_{1} {h}_{1}^{T} & {h}_{1} {h}_{0}^{T} \\ {h}_{0} {h}_{1}^{T} & {h}_{0} {h}_{0}^{T} + {h}_{1} {h}_{1}^{T}\end{matrix} ] . \qquad ( 15 )$$

The block matrix, H, is a convolution matrix. Thus, a received signal may be expressed at a time n (with an SoI not present, and neglecting additive noise for simplicity) as

$$z [ n ] = [ \begin{matrix}y [ n ] \\ y [ n - 1 ]\end{matrix} ] = [ \begin{matrix}{h}_{0} & {h}_{1} & 0 \\ 0 & {h}_{0} & {h}_{1}\end{matrix} ] [ \begin{matrix}x [ n ] \\ x [ n - 1 ] \\ x [ n - 2 ]\end{matrix} ] . \qquad ( 16 )$$

If x[n] is a white process, then the matrix HH^{T} can be directly computed as the covariance of x[n], as

C_{II}=HH^{T}=E[z[n]z[n]^{T}]. (17)

However, given the singularity of H, the null space of HH^{T} does not depend on the correlation sequence (i.e., power spectral density (PSD)) of x[n], and its support can be computed in all scenarios via the EVD of C_{II}.

For an interference channel involving any number of coupling paths, an equivalent formulation for the received signal, z[n], is

$$y [ n ] = [ {h}_{0} {h}_{1} … {h}_{P} ] [ \begin{matrix}x [ n ] \\ x [ n - 1 ] \\ ⋮ \\ x [ n - P + 1 ]\end{matrix} ] = \tilde{H} x [ n ] \\ z [ n ] = [ \begin{matrix}y [ n ] \\ y [ n - 1 ] \\ ⋮ \\ y [ n - L + 1\end{matrix} ] = ( I ⊗ \tilde{H} ) [ \begin{matrix}x [ n ] \\ x [ n - 1 ] \\ ⋮ \\ x [ n - L + 1\end{matrix} ] \\ {C}_{II} = ( I ⊗ \tilde{H} ) {{C}_{xx} ( I ⊗ \tilde{H} )}^{T} . \qquad ( 18 )$$

In equations 18, the channel matrix, \tilde{H}, is full-rank, but C_{II} remains singular because of the structure of Cₓₓ.

Given the above equations for modeling an interference channel involving multiple coupling paths, and a received signal that is affected by the interference channel, ST-NLIM may be applied.

Considering a scenario in which two physical Rx antennas (or RF chains) are mapped to one virtual antenna (one virtual antenna port), with ST-NLIM being used to mitigate the effects of an interference channel on an SoI, the mapped signal may be modeled as,

\tilde{y}[n]=W^{H}[n]*y[n]=W^{H}[n]*h[n]*s[n]+W^{H}[n]*h[n]*x[n]+W^{H}[n]*n[n], (19)

where \tilde{y}[n] is a 1×1 mapped signal matrix that represents a signal at a virtual antenna port, W^{H} [n] is a 1×2 mapping matrix (or finite impulse response (FIR) filter), y[n] is a 2×1 Rx signal matrix corresponding to a signal received at 2 physical Rx antennas, W^{H} [n]*h[n] is a 1×1 effective channel matrix (e.g., used for data demodulation), s[n] is a 1×1 SoI matrix (e.g., corresponding to one spatial stream), W^{H}[n]*h_{I}[n]*x[n] is the effective mapped and filtered interference, and n[n] is a 2×1 noise matrix (e.g., from thermal noise), all determined for an observation set of n sample time vectors. That is, a mapping matrix W^{H} (a space-time mapping matrix) may be applied to a signal received over 2 or more physical chains to obtain a virtual signal or spatial streams associated with a virtual antenna port. In addition to processing the mapped signal, the effective channel may be used for data demodulation in the frequency domain.

Assuming a pre-defined filter length of L taps, the vector convolution with the mapping matrix may be expressed as

$$\tilde{y} [ n ] = {\sum }_{k = 0}^{L - 1} {w}^{H} [ k ] y [ n - k ] = [ {w}^{H} [ 0 ] {w}^{H} [ 1 ] … {w}^{H} [ L + 1 ] ] [ \begin{matrix}y [ n ] \\ y [ n - 1 ] \\ ⋮ \\ y [ n - L + 1 ]\end{matrix} ] = {\tilde{w}}^{H} z [ n ] , \qquad ( 20 )$$

where several received sample time vectors in the interval [n−L+1,n] are stacked in a single 2L×1 observation set of sample time vectors (i.e., z[n]). The above model retains a clear resemblance to the model for space-only NLIM, and the mapping matrix w^{H} [n] (i.e., a space-time mapping matrix) can therefore be determined similarly to the space-only mapping matrix W^{H}, based on an EVD of the space-time covariance matrix:

$${C}_{II} = \frac{1}{N} {\sum }_{n = 0}^{N - 1} z [ n ] {z}^{H} [ n ] . \qquad ( 21 )$$

From the structure of the space-time covariance matrix provided in Equation (21), it can be seen that additive white noise (i.e., white in time in space) in a received signal would not change the eigenspace of the estimated space-time covariance:

$${C}_{II} = \frac{1}{N} {\sum }_{n = 0}^{N - 1} z [ n ] {z}^{H} [ n ] \approx {\tilde{C}}_{II} + {σ}_{N}^{2} \cdot I . \qquad ( 22 )$$

The eigenvectors of \tilde{C}_{H}, the interference space-time covariance matrix, are identical to the eigenvectors of C_{II}, the estimated space-time covariance matrix. The presence of colored noise, however, changes the eigenspace of the estimated covariance matrix, C_{II}, such that

$${C}_{II} = \frac{1}{N} {\sum }_{n = 0}^{N - 1} z [ n ] {z}^{H} [ n ] = {\tilde{C}}_{II} + {C}_{N} , \qquad ( 23 )$$

where C_{N} is the space-time covariance matrix of the noise only and is not an identity matrix.

Thermal noise would not be colored noise in the space domain, but could be colored noise in the time domain (e.g., as a result of oversampling and baseband filtering). In some examples, the noise covariance matrix may be computed via calibration (e.g., as an addition to noise-floor calibration) or based on knowledge of baseband filter impulse response. In some examples, the noise covariance matrix may be computed online (e.g., while actively receiving), during an interframe space (IFS) in which the interference being mitigated is not present.

After computing the space-time noise covariance matrix, C_{N}, the space-time noise covariance matrix may be used to adjust the estimated space-time covariance matrix, C_{II}. C_{II} may be adjusted before determining a mapping matrix based on C_{II}. In one example, the estimated space-time covariance matrix may be adjusted using a “whitening” approach, in which the estimated space-time covariance matrix is pre-multiplied with a square root of the noise space-time covariance matrix:

$${\hat{C}}_{II} - WHITENING = ( {C}_{N}^{- \frac{H}{2}} \cdot {C}_{II} \cdot {C}_{N} \cdot {C}_{N}^{- \frac{1}{2}} ) . \qquad ( 24 )$$

The above approach does not require knowledge of the actual noise floor level, and is independent of automatic gain control (AGC) operation. In another example, the estimated space-time covariance matrix may be adjusted using a “cleaning” process, in which the noise space-time covariance matrix is subtracted from the estimated space-time covariance matrix:

Ĉ_{II}−CLEANING=(C_{II}−C_{N}). (25)

The above approach does require knowledge of the actual noise floor level, which depends on the front-end gain settings dictated by AGC operation.

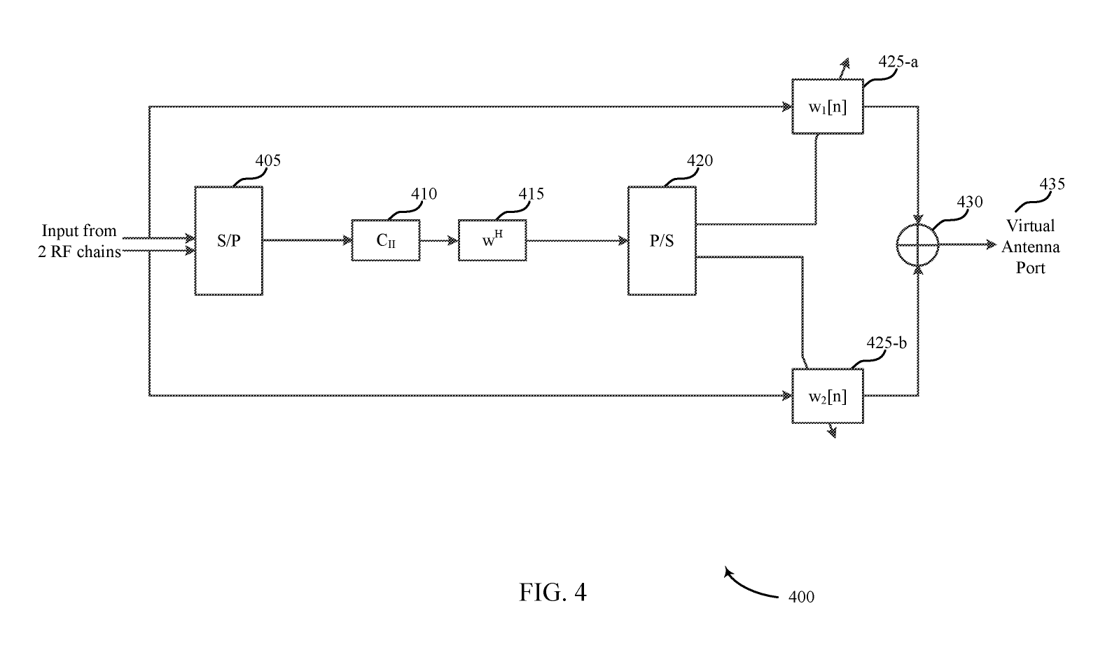

FIG. 4 illustrates an application of ST-NLIM to a signal received at a wireless device 400. By way of example, the wireless device 400 may receive the signal using two RF chains of the wireless device 400. Outputs of the two RF chains may be digitally sampled over a period of time, with the sampling resulting in a plurality of sample time vectors. Each sample time vector may be associated with a sample time and include digital samples corresponding to the two RF chains for the sample time.

The sample time vectors for the digitally sampled signal may be received by a serial-to-parallel (S/P) converter 405, and by first and second L-tap filters 425-a and 425-b. The S/P converter 405 may construct or define an observation set of digital samples, which observation set may include the digital samples of a plurality of sample time vectors. After processing is performed for the observation set of digital samples, the S/P converter 405 may construct a next observation set in a series of observation sets. To construct a next observation set, the S/P converter may discard one or more earlier-obtained sample time vectors included in a current observation set, and replace the discarded sample time vectors with one or more later-obtained sample time vectors, using a “sliding window” of sample time vectors approach.

A 2L×2L space-time covariance matrix computer 410 may receive an observation set of digital samples constructed by the S/P converter 405, and the matrix computer 410 may compute a space-time covariance matrix, C_{II}, for the observation set. The computed space-time covariance matrix may be provided to a 1×2L space-time mapping matrix computer 415, which may compute a space-time mapping matrix, w^{H}, corresponding to the space-time covariance matrix. The space-time mapping matrix may be determined, for example, based on EVD of the space-time covariance matrix.

The mapping matrix computed by the space-time mapping matrix computer 415 may be received by a P/S converter 420 that may select filter coefficients from the space-time mapping matrix, and use the selected filter coefficients to program the first and second L-tap filters 425-a and 425-b (i.e., the first L-tap filter 425-a, w₁[n] and the second L-tap filter 425-b, w₂[n].

A summer 430 may sum outputs of the first and second L-tap filters 425-a and 425-b to produce digital samples for a virtual antenna port 435.

In FIG. 4, the interference mitigation path is the same as for frequency domain NLIM (FD-NLIM), but the manner in which the filter taps are computed/selected is different. That is, instead of solving K 2×2 EVD problems (i.e., for FD-NLIM), a single, larger 2L×2L EVD problem is solved (i.e., for ST-NLIM). The filter taps for the first and second L-tap filters 425-a and 425-b may be the elements of an optimal 1×2L mapping matrix (or mapping vector) \tilde{w}. The filter taps may be read out from \tilde{w} based on a specific ordering of space-time dimensions within z[n].

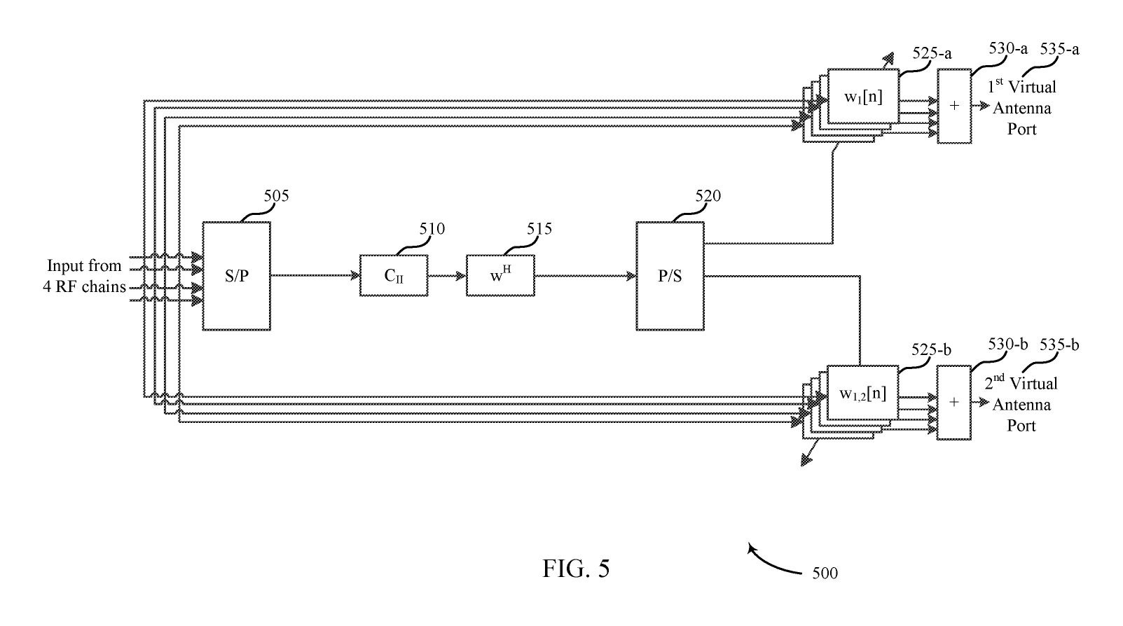

FIG. 5 illustrates another application of ST-NLIM to a signal received at a wireless device 500. By way of example, the signal may be received at the wireless device 500 using four RF chains of the wireless device 500. Outputs of the four RF chains may be digitally sampled over a period of time, with the sampling resulting in a plurality of sample time vectors. Each sample time vector may be associated with a sample time and include digital samples corresponding to the four RF chains for the sample time.

In FIG. 5, four RF chains are mapped to two virtual antennas (two virtual antenna ports). The mapped signal may be modeled as,

\tilde{y}[n]=W^{H}[n]*y[n]=W^{H}[n]*h[n]*s[n]+W^{H}[n]*h[n]*x[n]+W^{H}[n]*n[n], (26)

where \tilde{y}[n] is a 2×1 mapped signal matrix that represents a signal at a virtual antenna port, W^{H}[n] is a 2×4 mapping matrix (or finite impulse response (FIR) filter), y[n] is a 4×1 Rx signal matrix corresponding to a signal received at 4 physical Rx antennas, W^{H}[n]*h[n] is a 2×2 effective channel matrix (e.g., used for data demodulation), s[n] is a 2×2 SoI matrix (e.g., corresponding to two spatial streams), W^{H}[n]*h_{I}[n]*x[n] is the effective mapped and filtered interference, and n[n] is a 2×1 noise matrix (e.g., from thermal noise), all determined for an observation set of n sample time vectors.

The sample time vectors for the digitally sampled signal may be received by a serial-to-parallel (S/P) converter 505, and by first and second banks 525-a and 525-b of L-tap filters. The S/P converter 505 may construct or define an observation set of digital samples, which observation set may include the digital samples of a plurality of sample time vectors. After processing is performed for the observation set of digital samples, the S/P converter 505 may construct a next observation set in a series of observation sets. To construct a next observation set, the S/P converter may discard one or more earlier-obtained sample time vectors included in a current observation set, and replace the discarded sample time vectors with one or more later-obtained sample time vectors, using a “sliding window” of sample time vectors approach.

An observation set of digital samples constructed by the S/P converter 505 may be received by a 4L×4L space-time covariance matrix computer 510, which may compute a space-time covariance matrix, C_{II}, for the observation set. The computed space-time covariance matrix may be provided to a 2×4L space-time mapping matrix computer 515, which may compute a space-time mapping matrix, w^{H}, corresponding to the space-time covariance matrix. The space-time mapping matrix may be determined, for example, based on EVD of the space-time covariance matrix.

The mapping matrix computed by the space-time mapping matrix computer 515 may be received by a P/S converter 520 that may select filter coefficients from the space-time mapping matrix, and use the selected filter coefficients to program the first and second banks 525-a and 525-b of L-tap filters (i.e., a first bank 525-a of four L-tap filters, w_{1,1}[n]−w_{4,1}[n], and a second bank 525-b of four L-tap filters, w_{1,2}[n]−w_{4,2}[n]).

A first summer 530-a may sum outputs of the first bank 525-a of L-tap filters, and a second summer 530-b may sum outputs of the second bank 525-b of L-tap filters, to produce digital samples for first and second virtual antenna ports 535-a and 535-b.

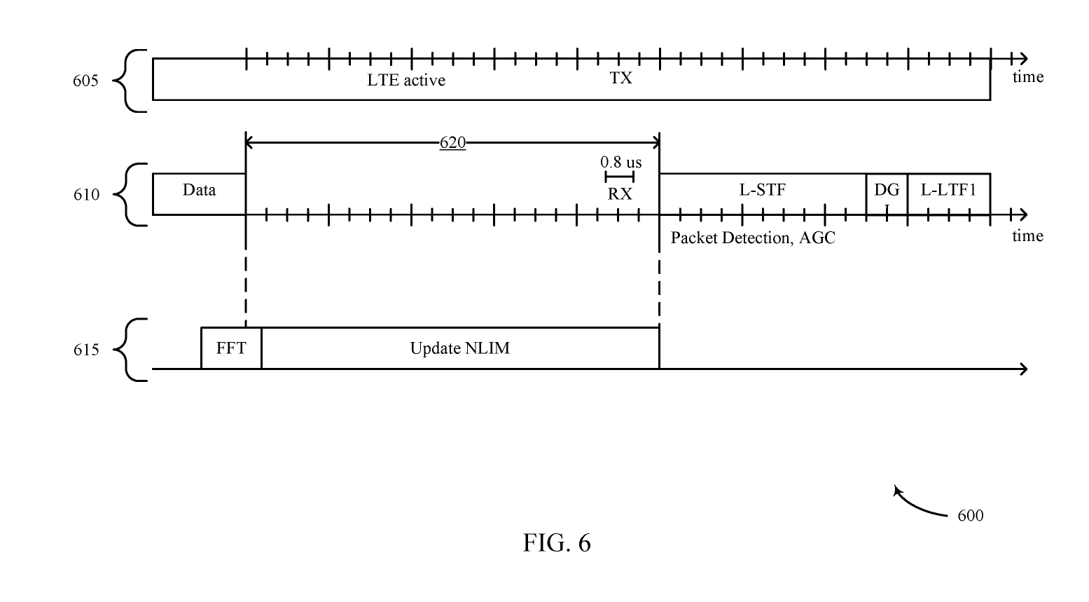

FIG. 6 illustrates an example of a processing timeline 600 that supports interference mitigation via subspace projection (e.g., space subspace projection or space-time subspace projection). According to the example of FIG. 6, a spatial covariance matrix of the interference plus noise, C_{II}, may be computed to update or train NLIM coefficients (which for the purpose of FIG. 6 may include space or space-time NLIM coefficients). In general, the interference channel, h_{I}, may not be known and C_{II} may be used to obtain the spatial mapping matrix, W. Transmission timeline 605, reception timeline 610, and NLIM processing timeline 615 may illustrate NLIM coefficient updating during, for example, SoI reception idle periods.

The example of FIG. 6 may, for example, apply to Wi-Fi implementations where gaps 620 (e.g., interframe spaces) exist between transmitted and received packets. Gap 620 may not be fixed and may depend on several parameters. In some cases, the gap 620 may include an SIFS (e.g., 16 us). When an aggressor is transmitting within a gap 620 (e.g., LTE active along transmission timeline 605), samples received during the gap 620 (e.g., samples received along reception timeline 610) may be used to compute the second order statistics of the interference (e.g., see Equation 3, 21, 22, or 23). Such computations may be used to train coefficients used in NLIM (e.g., to determine the spatial mapping matrix W, see Equation 4). That is, NLIM may be updated along NLIM processing timeline 615 during gap 620.

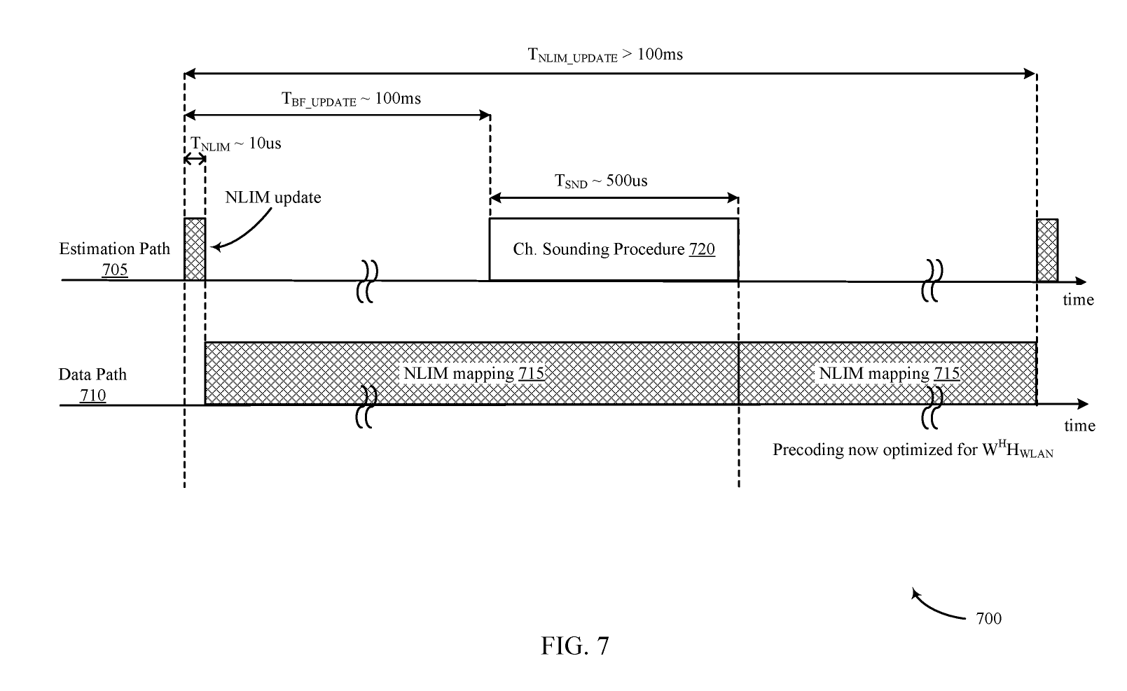

FIG. 7 illustrates an example of a processing timeline 700 that supports interference mitigation via subspace projection (e.g., space subspace projection or space-time subspace projection). NLIM may be represented in the context of a channel sounding procedure in Wi-Fi. A data path employing NLIM mapping 715 may underlie an estimation path 705 used for a channel sounding procedure 720 to increase effectiveness of AP 105 precoding.

When Wi-Fi employs MIMO, an accompanying channel sounding procedure may be used to compute an optimal precoding that a transmitter (e.g., AP 105) should employ. AP 105 may start a channel sounding procedure 720 or an exchange of packets for channel estimation. In some cases, NLIM mapping 715 may underlie operation of the channel sounding procedure 720. In such cases, the precoding an AP 105 chooses may be optimized for the effective channel, W^{H}H or W^{H}[n]*H[n], which may be the result of the NLIM operation. The AP 105 tuning to the effective channel W^{H}H or W^{H}[n]*H[n], instead of the original channel H or H[n], which is what the modem receives after NLIM mapping 715 and may thus result in increased overall NLIM performance.

At a receiver (e.g., a UE), the receiver may estimate a channel for data demodulation using training sequences and/or pilot symbols embedded in a frame sent by a transmitter (e.g., an AP).

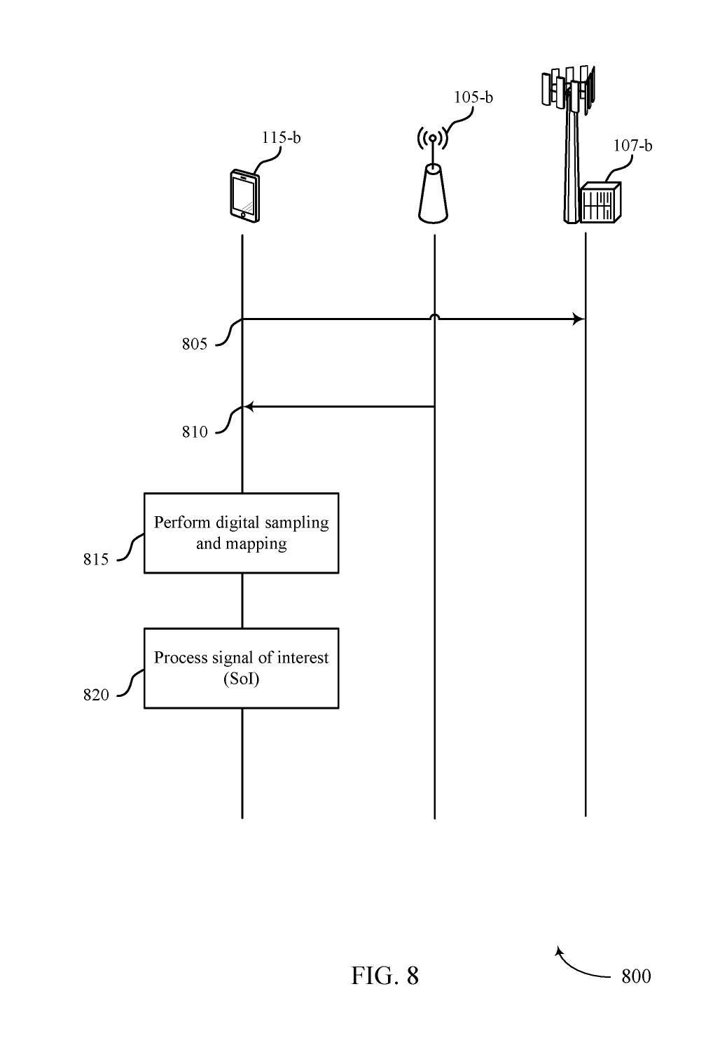

FIG. 8 illustrates an example of a process flow 800 that supports interference mitigation via space-time subspace projection. Process flow 800 may illustrate an example of a procedure for interference mitigation via subspace projection implemented by a wireless device using multiple RATs with co-located radios (e.g., wireless device 115-b).

At 805, wireless device 115-b may transmit one or more signals using one or more RF chains associated with a radio configured for a first RAT (e.g., an LTE transmission) to base station 107-b. At 810, wireless device 115-b may receive a signal using RF chains associated with a radio configured for a second RAT (e.g., a WLAN transmission) from AP 105-b. In some cases, 805 and 810 may occur simultaneously. The physical antennas of each RF chain of 805 and 810 may correspond to a number of receive antennas of wireless device 115-b.

At 815, wireless device 115-b may digitally sample the signal received at 810, over a period of time, at outputs of the plurality of RF chains. The sampling may result in a plurality of sample time vectors. Each sample time vector may include a plurality of digital samples corresponding to the plurality of RF chains for a sample time. Also at 815, wireless device 115-b may map the digitally sampled signal to a set of one or more virtual antenna ports of wireless device 115-b. The mapping may be performed for one or more observation sets of digital samples of the signal. Each observation set may represent a window of sample time vectors. In some examples, the mapping may be based at least in part on mitigating interference of an SoI.

A mapping matrix used to perform 815 may be determined based on an EVD of a spatial covariance matrix for reception of the signal at 810. The spatial covariance matrix may be determined during a period of idle mode reception. Specifically, the values of the mapping matrix may be computed based on the smallest eigenvalues of the EVD. Virtual antenna ports associated with weaker interference may be realized based on such computations. Additionally or alternatively, the values of the mapping matrix may be computed based on an interference channel using a Gram-Schmidt orthonormalization procedure. Further, a channel matrix for data demodulation may be determined during a sounding interval based on the mapping matrix.

At 820, wireless device 115-b may process the SoI by processing digital samples associated with the set of one or more virtual antenna ports.

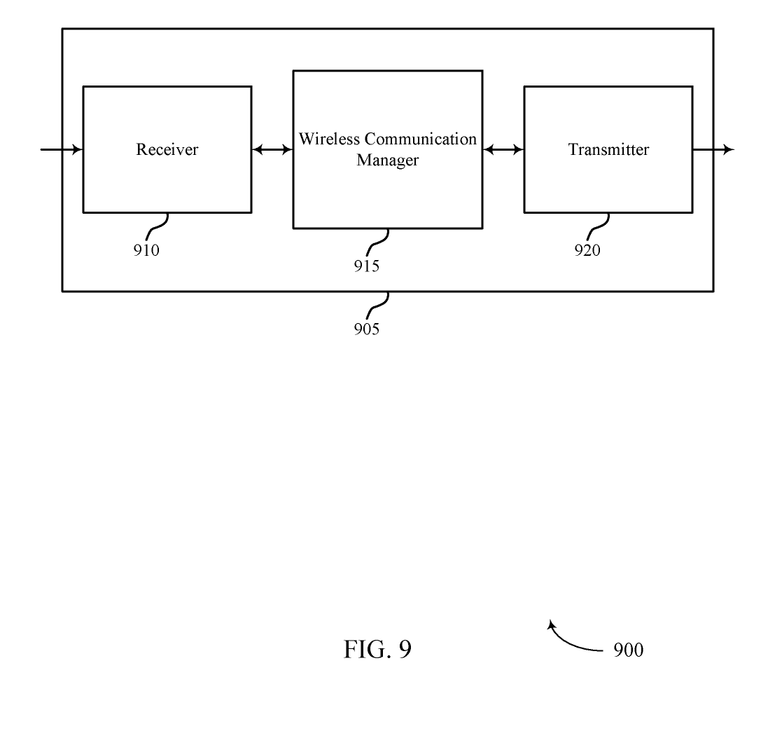

FIG. 9 shows a block diagram 900 of a wireless device 905 that supports interference mitigation via space-time subspace projection in accordance with various aspects of the present disclosure. Wireless device 905 may be an example of aspects of a wireless device 115 as described with reference to FIG. 1. Wireless device 905 may include receiver 910, wireless communication manager 915, and transmitter 920. Wireless device 905 may also include a processor. Each of these components may be in communication with one another (e.g., via one or more buses).

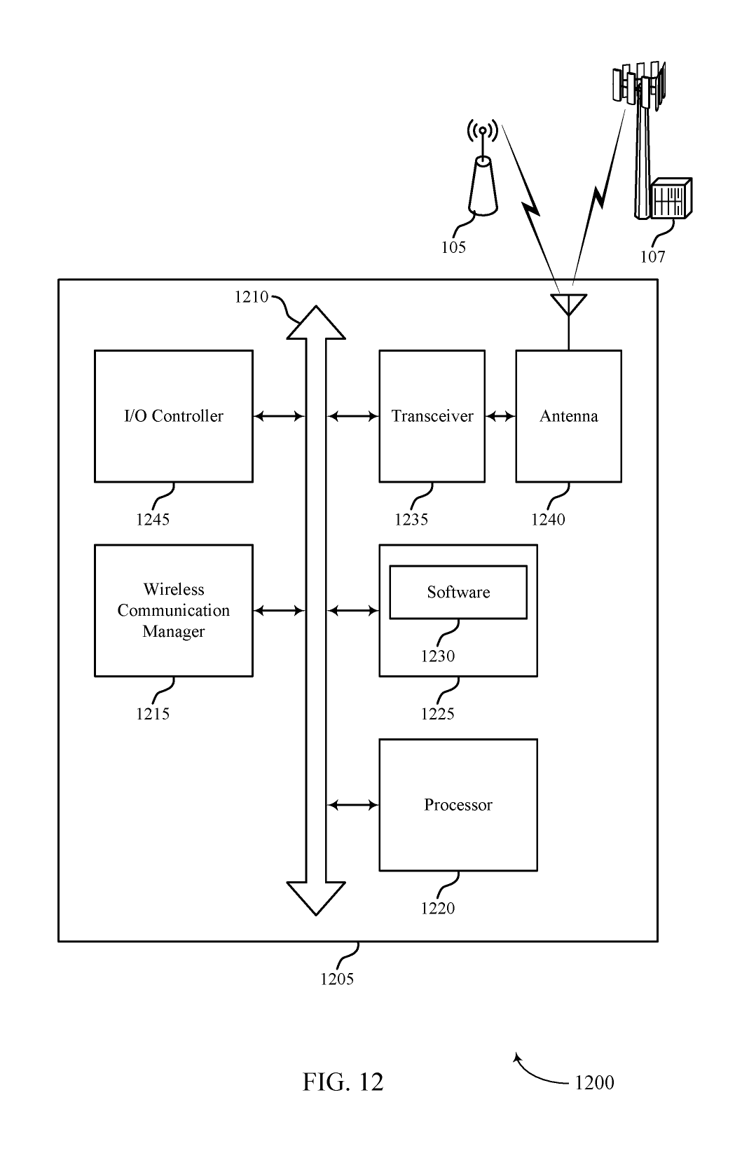

Receiver 910 may receive information such as packets, user data, or control information associated with various information channels (e.g., control channels, data channels, and information related to interference mitigation with subspace projection, etc.). Information may be passed on to other components of the device. The receiver 910 may be an example of aspects of the transceiver 1235 described with reference to FIG. 12.

Wireless communication manager 915 may be an example of aspects of the wireless communication manager 1215 described with reference to FIG. 12. Wireless communication manager 915 may be used to receive a signal using a plurality of RF chains of the wireless device 905 (e.g., RF chains of receiver 910), and may digitally sample the signal over a period of time at outputs of the plurality of RF chains. The sampling may result in a plurality of sample time vectors. Each sample time vector may include a plurality of digital samples corresponding to the plurality of RF chains for a sample time. Wireless communication manager 915 may also be used to map the digitally sampled signal to a set of one or more virtual antenna ports. The mapping may be performed for one or more observation sets of digital samples of the signal. Each observation set may represent a window of sample time vectors. Wireless communication manager 915 may also be used to process an SoI by processing digital samples associated with the set of one or more virtual antenna ports.

Transmitter 920 may transmit signals generated by other components of the device. In some examples, the transmitter 920 may be collocated with the receiver 910 in a transceiver. For example, the transmitter 920 may be an example of aspects of the transceiver 1235 described with reference to FIG. 12. The transmitter 920 may include a single antenna, or it may include a set of antennas.

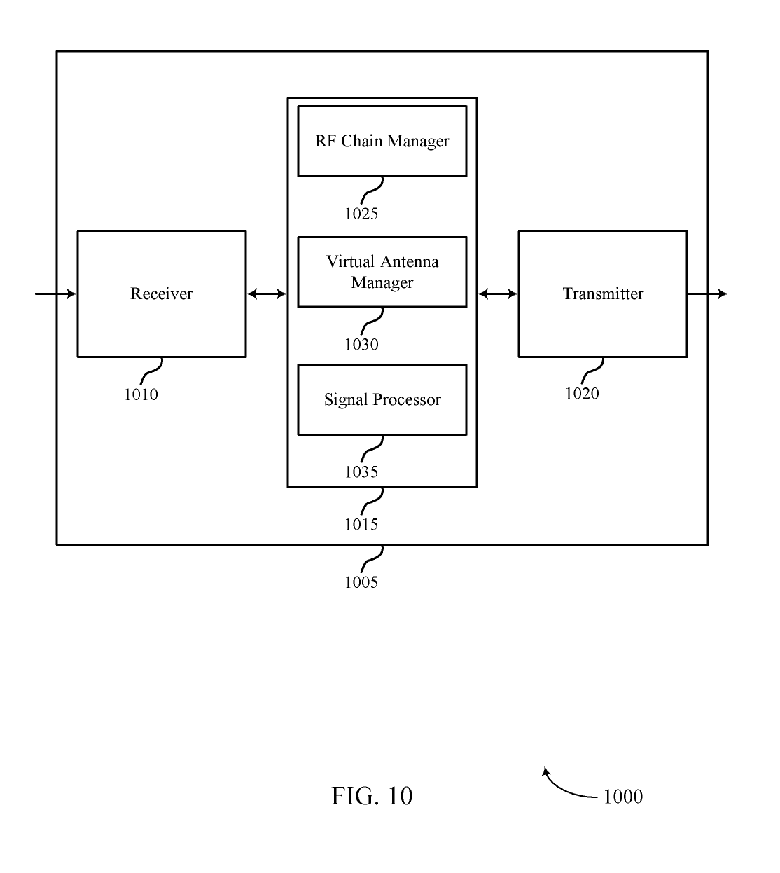

FIG. 10 shows a block diagram 1000 of a wireless device 1005 that supports interference mitigation via space-time subspace projection in accordance with various aspects of the present disclosure. Wireless device 1005 may be an example of aspects of a wireless device 115 or a wireless device 905 as described with reference to FIGS. 1 and 9. Wireless device 1005 may include receiver 1010, wireless communication manager 1015, and transmitter 1020. Wireless device 1005 may also include a processor. Each of these components may be in communication with one another (e.g., via one or more buses).

Receiver 1010 may receive information such as packets, user data, or control information associated with various information channels (e.g., control channels, data channels, and information related to interference mitigation with subspace projection, etc.). Information may be passed on to other components of the device. The receiver 1010 may be an example of aspects of the transceiver 1235 described with reference to FIG. 12.

Wireless communication manager 1015 may be an example of aspects of the wireless communication manager 1215 described with reference to FIG. 12. Wireless communication manager 1015 may also include RF chain manager 1025, a virtual antenna manager 1030, and a signal processor 1035.

RF chain manager 1025 may be used to receive a signal using a plurality of RF chains of the wireless device 1005 (e.g., RF chains of receiver 1010). RF chain manager 1025 may also be used to transmit at least one signal using at least one RF chain of the wireless device (e.g., at least one RF chain of transmitter 1020). In some examples, the received signal may be received during transmission of the at least one transmitted signal. In some examples, the at least one transmitted signal may be transmitted before, during, and/or after reception of the received signal. In some examples, the received signal may be received according to a first RAT (e.g., a WLAN RAT), and at least one of the transmitted signal(s) may be transmitted according to a second RAT (e.g., a WWAN RAT). In some examples, RF chain manager 1025 may also be used to digitally sample the received signal over a period of time, at outputs of the plurality of RF chains. The sampling may result in a plurality of sample time vectors. Each sample time vector may include a plurality of digital samples corresponding to the plurality of RF chains for a sample time.

Virtual antenna manager 1030 may be used to map the digitally sampled signal to a set of one or more virtual antenna ports. The mapping may be performed for one or more observation sets of digital samples of the signal. Each observation set may represent a window of sample time vectors.

Signal processor 1035 may be used to process an SoI by processing digital samples associated with the set of one or more virtual antenna ports.

Transmitter 1020 may transmit signals generated by other components of the device. In some examples, the transmitter 1020 may be collocated with the receiver 1010 in a transceiver. For example, the transmitter 1020 may be an example of aspects of the transceiver 1235 described with reference to FIG. 12. The transmitter 1020 may include a single antenna, or it may include a set of antennas.

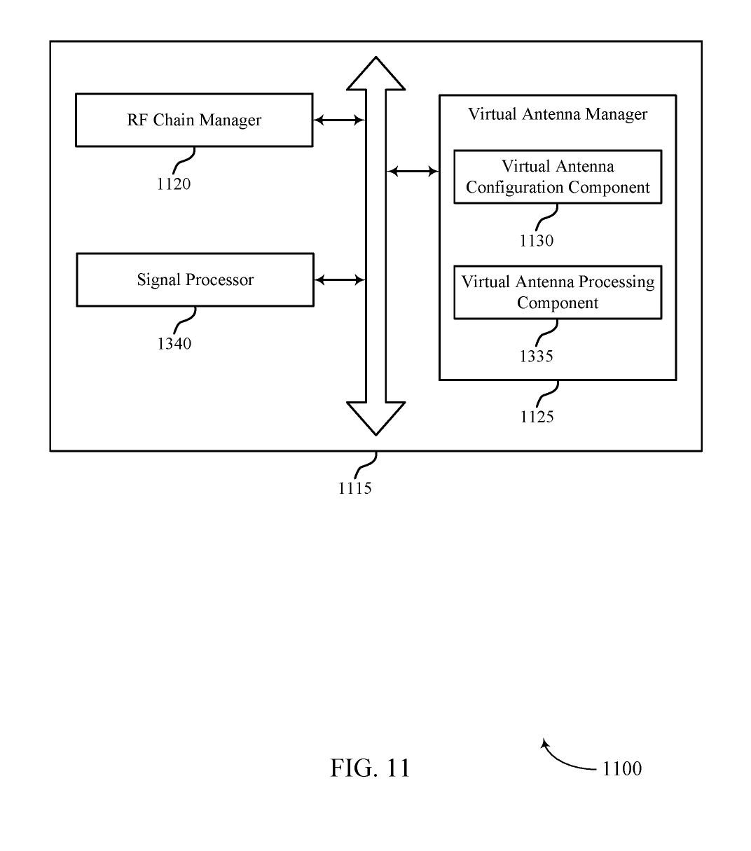

FIG. 11 shows a block diagram 1100 of a wireless communication manager 1115 that supports interference mitigation via space-time subspace projection in accordance with various aspects of the present disclosure. The wireless communication manager 1115 may be an example of aspects of a wireless communication manager 915, a wireless communication manager 1015, or a wireless communication manager 1215 described with reference to FIGS. 9, 10, and 12. The wireless communication manager 1115 may include RF chain manager 1120, virtual antenna manager 1125, and signal processor 1140. The virtual antenna manager 1125 may further include virtual antenna configuration component 1130 and virtual antenna processing component 1135. Each of these components may communicate, directly or indirectly, with one another (e.g., via one or more buses).

RF chain manager 1120 may be used to receive a signal using a plurality of RF chains of a wireless device. RF chain manager 1120 may also be used to transmit at least one signal using at least one RF chain of the wireless device. In some examples, the received signal may be received during transmission of the at least one transmitted signal. In some examples, the at least one transmitted signal may be transmitted before, during, and/or after reception of the received signal. In some examples, the received signal may be received according to a first RAT (e.g., a WLAN RAT), and at least one of the transmitted signal(s) may be transmitted according to a second RAT (e.g., a WWAN RAT). In some examples, RF chain manager 1120 may also be used to digitally sample the received signal over a period of time, at outputs of the plurality of RF chains. The sampling may result in a plurality of sample time vectors. Each sample time vector may include a plurality of digital samples corresponding to the plurality of RF chains for a sample time.

Virtual antenna configuration component 1130 may be used to identify an SoI. Virtual antenna configuration component 1130 may also be used to identify an interference channel contributing to interference of the SoI. In some examples, the interference channel may be associated with the transmission of the at least one signal using RF chain manager 1120. In some examples, the interference channel may be based on interference associated with at least one of duplexer and tuner impedance mismatch of the RF chains, non-linearity of transfer functions of power amplifiers in the RF chains, limited RF isolation between different RF chains, limited isolation between physical antennas associated with different RF chains, or a combination thereof. Virtual antenna configuration component 1130 may also be used to determine a space-time covariance matrix for reception of the signal using the plurality of RF chains. In some examples, the space-time covariance matrix may be determined during periods of idle mode reception at a wireless device.

Virtual antenna configuration component 1130 may also be used to adjust the space-time covariance matrix. The adjustment may be performed before determining a mapping matrix. In some examples, the space-time covariance matrix may be adjusted by pre-multiplying the space-time covariance matrix by a square root matrix of a noise space-time covariance matrix associated with the signal, to produce a product, and by post-multiplying the product by a Hermitian transpose of the square root matrix. In some examples, the space-time covariance matrix may be adjusted by subtracting a noise space-time covariance matrix from the space-time covariance matrix.

Virtual antenna configuration component 1130 may also be used to determine a mapping matrix based at least in part on an EVD of the space-time covariance matrix. In some examples, values of the mapping matrix may be computed based at least in part on a set of smallest eigenvalues of the EVD. In some examples, values of the mapping matrix may be computed based at least in part on the interference channel using a Gram-Schmidt orthonormalization procedure.

Virtual antenna configuration component 1130 may also be used to determine a channel matrix for data demodulation during a channel estimation procedure interval. The channel matrix for data demodulation may be based at least in part on the mapping matrix.

Virtual antenna processing component 1135 may be used to map the digitally sampled signal to a set of one or more virtual antenna ports. The mapping may be performed for one or more observation sets of digital samples of the signal. Each observation set may represent a window of sample time vectors. In some examples, the mapping may be based at least in part on mitigating the interference of the SoI. In some examples, the mapping may be based at least in part on the mapping matrix (e.g., on the computed values of the mapping matrix). In some examples, the mapping may include performing, for each observation set of digital samples of the signal, a linear convolution of the mapping matrix with the observation set. In some examples, the mapping may include setting, based at least in part on the mapping matrix, filter coefficients for a set of multi-tap digital filters; processing each observation set of digital samples of the signal through the set of multi-tap digital filters; and generating a set of digital samples for each of the one or more virtual antenna ports by summing, for each of the one or more virtual antenna ports, a set of outputs of a subset of the set of multi-tap digital filters.

Signal processor 1140 may be used to process an SoI by processing digital samples associated with the set of one or more virtual antenna ports.

FIG. 12 shows a diagram of a system 1200 including a device 1205 that supports interference mitigation via space-time subspace projection in accordance with various aspects of the present disclosure. Device 1205 may be an example of or include the components of wireless device 905, wireless device 1005, or a wireless device 115 as described above, for example, with reference to FIGS. 1, 9 and 10. Device 1205 may include components for bi-directional voice and data communications including components for transmitting and receiving communications, including wireless communication manager 1215, processor 1220, memory 1225, software 1230, transceiver 1235, antenna 1240, and I/O controller 1245. These components may be in electronic communication via one or more busses (e.g., bus 1210). Device 1205 may communicate wirelessly with one or more APs 105 or base stations 107.

Processor 1220 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting interference mitigation with space-time subspace projection).

Memory 1225 may include random access memory (RAM) and read only memory (ROM). The memory 1225 may store computer-readable, computer-executable software 1230 including instructions that, when executed, cause the processor to perform various functions described herein. In some cases, the memory 1225 may contain, among other things, a basic input/output system (BIOS) which may control basic hardware and/or software operation such as the interaction with peripheral components or devices.

Software 1230 may include code to implement aspects of the present disclosure, including code to support interference mitigation with space-time subspace projection. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

I/O controller 1245 may manage input and output signals for device 1205. I/O controller 1245 may also manage peripherals not integrated into device 1205. In some cases, I/O controller 1245 may represent a physical connection or port to an external peripheral. In some cases, I/O controller 1245 may utilize an operating system such as iOS®, ANDROID®, MS-DOS®, MS-WINDOWS®, OS/2®, UNIX®, LINUX®, or another known operating system.

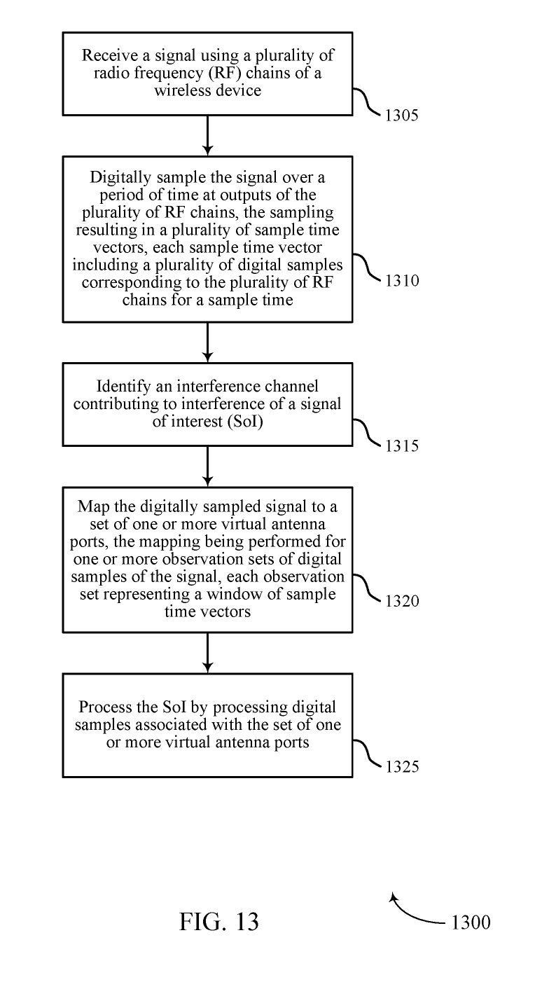

FIG. 13 shows a flowchart illustrating a method 1300 for wireless communication in accordance with various aspects of the present disclosure. The operations of method 1300 may be implemented by a wireless device 115 or its components as described herein. For example, the operations of method 1300 may be performed by a wireless communication manager as described with reference to FIGS. 9-14. In some examples, a wireless device 115 may execute a set of codes to control the functional elements of the device to perform the functions described below. Additionally or alternatively, the wireless device 115 may perform aspects of the functions described below using special-purpose hardware.

At block 1305, the wireless device 115 may receive a signal using a plurality of RF chains of a wireless device. The operations of block 1305 may be performed according to the techniques described with reference to FIGS. 1-8. In certain examples, aspects of the operations of block 1305 may be performed using a RF chain manager as described with reference to FIGS. 10-11.

At block 1310, the wireless device 115 may digitally sample the signal over a period of time at outputs of the plurality of RF chains, resulting in a plurality of sample time vectors. Each sample time vector may include a plurality of digital samples corresponding to the plurality of RF chains for a sample time. The operations of block 1310 may be performed according to the techniques described with reference to FIGS. 1-8. In certain examples, aspects of the operations of block 1310 may be performed using a RF chain manager as described with reference to FIGS. 10-11.

At block 1315, the wireless device 115 may identify an interference channel contributing to interference of an Sot In some examples, the interference channel may be based on interference associated with at least one of duplexer and tuner impedance mismatch of the RF chains, non-linearity of transfer functions of power amplifiers in the RF chains, limited RF isolation between different RF chains, limited isolation between physical antennas associated with different RF chains, or a combination thereof. The operations of block 1315 may be performed according to the techniques described with reference to FIGS. 1-8. In certain examples, aspects of the operations of block 1315 may be performed by a virtual antenna manager as described with reference to FIGS. 10-11, or by a virtual antenna configuration component as described with reference to FIG. 11.

At block 1320, the wireless device 115 maps the digitally sampled signal to a set of one or more virtual antenna ports. The mapping may be performed for one or more observation sets of digital samples of the signal. Each observation set may represent a window of sample time vectors. The operations of block 1320 may be performed according to the techniques described with reference to FIGS. 1-8. In certain examples, aspects of the operations of block 1320 may be performed by a virtual antenna manager as described with reference to FIGS. 10-11, or by a virtual antenna processing component as described with reference to FIG. 11.

At block 1325, the wireless device 115 may process the SoI by processing digital samples associated with the set of one or more virtual antenna ports. The operations of block 1325 may be performed according to the techniques described with reference to FIGS. 1-8. In certain examples, aspects of the operations of block 1325 may be performed by a signal processor as described with reference to FIGS. 10-11.

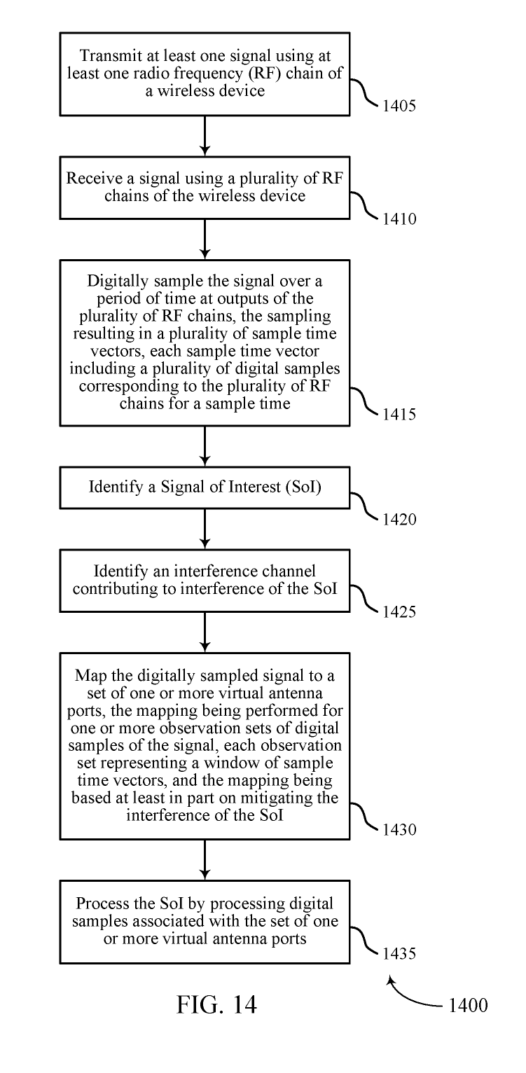

FIG. 14 shows a flowchart illustrating a method 1400 for wireless communication in accordance with various aspects of the present disclosure. The operations of method 1400 may be implemented by a wireless device 115 or its components as described herein. For example, the operations of method 1400 may be performed by a wireless communication manager as described with reference to FIGS. 9-12. In some examples, a wireless device 115 may execute a set of codes to control the functional elements of the device to perform the functions described below. Additionally or alternatively, the wireless device 115 may perform aspects of the functions described below using special-purpose hardware.

At block 1405, the wireless device 115 may transmit at least one signal using at least one RF chain of a wireless device. The operations of block 1405 may be performed according to the techniques described with reference to FIGS. 1-8. In certain examples, aspects of the operations of block 1405 may be performed using a RF chain manager as described with reference to FIGS. 10-11.

At block 1410, the wireless device 115 may receive a signal using a plurality of RF chains of the wireless device. The operations of block 1410 may be performed according to the techniques described with reference to FIGS. 1-8. In certain examples, aspects of the operations of block 1410 may be performed by a RF chain manager as described with reference to FIGS. 10-11.

In some examples, the signal may be received during transmission of the at least one signal transmitted at block 1405. In some examples, the at least one signal transmitted at block 1405 may be transmitted before, during, and/or after reception of the signal at block 1410. In some examples, the received signal may be received according to a first RAT (e.g., a WLAN RAT), and at least one of the transmitted signal(s) may be transmitted according to a second RAT (e.g., a WWAN RAT).

At block 1415, the wireless device 115 may digitally sample the signal over a period of time at outputs of the plurality of RF chains, resulting in a plurality of sample time vectors. Each sample time vector may include a plurality of digital samples corresponding to the plurality of RF chains for a sample time. The operations of block 1415 may be performed according to the techniques described with reference to FIGS. 1-8. In certain examples, aspects of the operations of block 1415 may be performed by a RF chain manager as described with reference to FIGS. 10-11.

At block 1420, the wireless device 115 may identify an Sot In some examples, the operations of block 1420 may be performed prior to or during the operations of blocks 1405, 1410, or 1415. The operations of block 1420 may be performed according to the techniques described with reference to FIGS. 1-8. In certain examples, aspects of the operations of block 1420 may be performed by a virtual antenna manager as described with reference to FIGS. 10-11, or by a virtual antenna configuration component as described with reference to FIG. 11.

At block 1425, the wireless device 115 may identify an interference channel contributing to interference of the SoI. In some examples, the interference channel may be associated with the transmission of the at least one signal at block 1405. In some examples, the interference channel may be based on interference associated with at least one of duplexer and tuner impedance mismatch of the RF chains, non-linearity of transfer functions of power amplifiers in the RF chains, limited RF isolation between different RF chains, limited isolation between physical antennas associated with different RF chains, or a combination thereof. In some examples, the operations of block 1425 may be performed prior to or during the operations of blocks 1405, 1410, 1415, or 1420. The operations of block 1425 may be performed according to the techniques described with reference to FIGS. 1-8. In certain examples, aspects of the operations of block 1425 may be performed by a virtual antenna manager as described with reference to FIGS. 10-11, or by a virtual antenna configuration component as described with reference to FIG. 11.

At block 1430, the wireless device 115 map the digitally sampled signal to a set of one or more virtual antenna ports. The mapping may be performed for one or more observation sets of digital samples of the signal. Each observation set may represent a window of sample time vectors. In some examples, the mapping may be based at least in part on mitigating the interference of the SoI. The operations of block 1430 may be performed according to the techniques described with reference to FIGS. 1-8. In certain examples, aspects of the operations of block 1430 may be performed by a virtual antenna manager as described with reference to FIGS. 10-11, or by a virtual antenna processing component as described with reference to FIG. 11.

At block 1435, the wireless device 115 may process the SoI by processing digital samples associated with the set of one or more virtual antenna ports. The operations of block 1435 may be performed according to the techniques described with reference to FIGS. 1-8. In certain examples, aspects of the operations of block 1435 may be performed by a signal processor as described with reference to FIGS. 10-11.

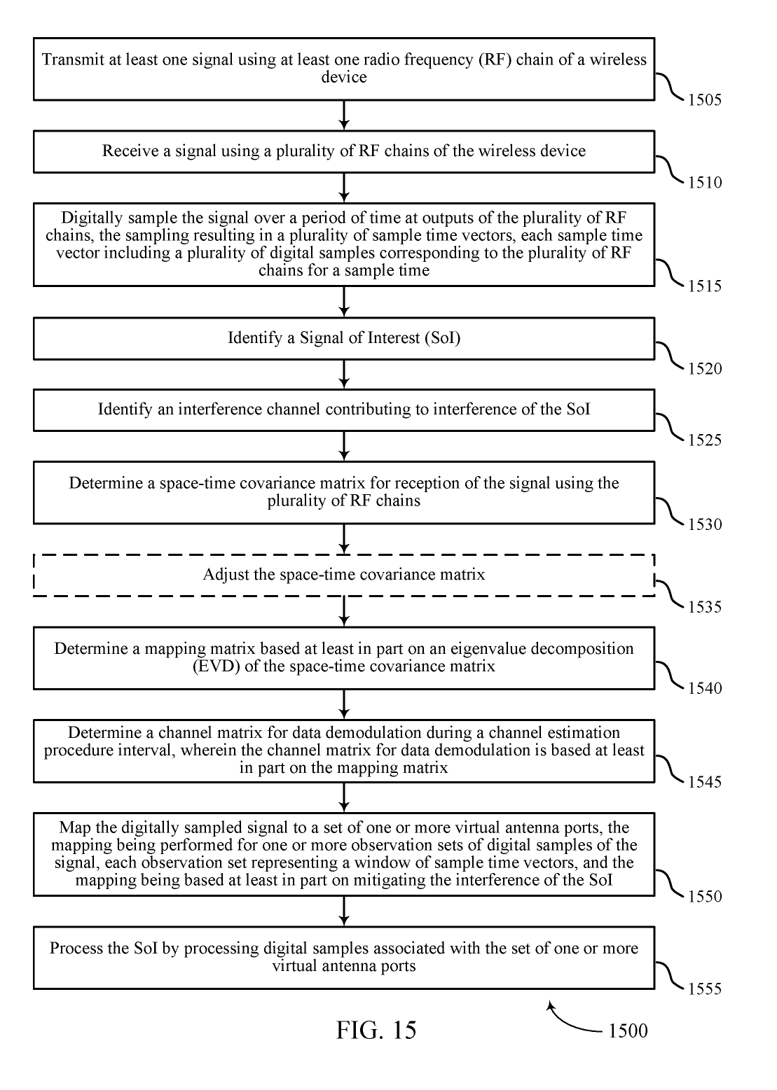

FIG. 15 shows a flowchart illustrating a method 1500 for wireless communication in accordance with various aspects of the present disclosure. The operations of method 1500 may be implemented by a wireless device 115 or its components as described herein. For example, the operations of method 1500 may be performed by a wireless communication manager as described with reference to FIGS. 9-12. In some examples, a wireless device 115 may execute a set of codes to control the functional elements of the device to perform the functions described below. Additionally or alternatively, the wireless device 115 may perform aspects of the functions described below using special-purpose hardware.

At block 1505, the wireless device 115 may transmit at least one signal using at least one RF chain of a wireless device. The operations of block 1505 may be performed according to the techniques described with reference to FIGS. 1-8. In certain examples, aspects of the operations of block 1505 may be performed using a RF chain manager as described with reference to FIGS. 10-11.

At block 1510, the wireless device 115 may receive a signal using a plurality of RF chains of the wireless device. The operations of block 1510 may be performed according to the techniques described with reference to FIGS. 1-8. In certain examples, aspects of the operations of block 1510 may be performed by a RF chain manager as described with reference to FIGS. 10-11.

In some examples, the signal may be received during transmission of the at least one signal transmitted at block 1505. In some examples, the at least one signal transmitted at block 1505 may be transmitted before, during, and/or after reception of the signal at block 1510. In some examples, the received signal may be received according to a first RAT (e.g., a WLAN RAT), and at least one of the transmitted signal(s) may be transmitted according to a second RAT (e.g., a WWAN RAT).

At block 1515, the wireless device 115 may digitally sample the signal over a period of time at outputs of the plurality of RF chains, resulting in a plurality of sample time vectors. Each sample time vector may include a plurality of digital samples corresponding to the plurality of RF chains for a sample time. The operations of block 1515 may be performed according to the techniques described with reference to FIGS. 1-8. In certain examples, aspects of the operations of block 1515 may be performed by a RF chain manager as described with reference to FIGS. 10-11.

At block 1520, the wireless device 115 may identify an Sot In some examples, the operations of block 1520 may be performed prior to or during the operations of blocks 1505, 1510, or 1515. The operations of block 1520 may be performed according to the techniques described with reference to FIGS. 1-8. In certain examples, aspects of the operations of block 1520 may be performed by a virtual antenna manager as described with reference to FIGS. 10-11, or by a virtual antenna configuration component as described with reference to FIG. 11.

At block 1525, the wireless device 115 may identify an interference channel contributing to interference of the SoI. In some examples, the interference channel may be associated with the transmission of the at least one signal at block 1505. In some examples, the interference channel may be based on interference associated with at least one of duplexer and tuner impedance mismatch of the RF chains, non-linearity of transfer functions of power amplifiers in the RF chains, limited RF isolation between different RF chains, limited isolation between physical antennas associated with different RF chains, or a combination thereof. In some examples, the operations of block 1525 may be performed prior to or during the operations of blocks 1505, 1510, 1515, or 1520. The operations of block 1525 may be performed according to the techniques described with reference to FIGS. 1-8. In certain examples, aspects of the operations of block 1525 may be performed by a virtual antenna manager as described with reference to FIGS. 10-11, or by a virtual antenna configuration component as described with reference to FIG. 11.

At block 1530, the wireless device 115 may determine a space-time covariance matrix for reception of the signal using the plurality of RF chains. In some examples, the space-time covariance matrix may be determined during periods of idle mode reception at the wireless device. The operations of block 1530 may be performed according to the techniques described with reference to FIGS. 1-8. In certain examples, aspects of the operations of block 1530 may be performed by a virtual antenna manager as described with reference to FIGS. 10-11, or by a virtual antenna configuration component as described with reference to FIG. 11.

At block 1535, the wireless device 115 may optionally adjust the space-time covariance matrix. The adjustment may be performed before determining a mapping matrix at block 1540. In some examples, the space-time covariance matrix may be adjusted by pre-multiplying the space-time covariance matrix by a square root matrix of a noise space-time covariance matrix associated with the signal, to produce a product, and by post-multiplying the product by a Hermitian transpose of the square root matrix. In some examples, the space-time covariance matrix may be adjusted by subtracting a noise space-time covariance matrix from the space-time covariance matrix. The operations of block 1530 may be performed according to the techniques described with reference to FIGS. 1-8. In certain examples, aspects of the operations of block 1530 may be performed by a virtual antenna manager as described with reference to FIGS. 10-11, or by a virtual antenna configuration component as described with reference to FIG. 11.

At block 1540, the wireless device 115 may determine a mapping matrix based at least in part on an EVD of the space-time covariance matrix. In some examples, values of the mapping matrix may be computed based at least in part on a set of smallest eigenvalues of the EVD. In some examples, values of the mapping matrix may be computed based at least in part on the interference channel using a Gram-Schmidt orthonormalization procedure. The operations of block 1530 may be performed according to the techniques described with reference to FIGS. 1-8. In certain examples, aspects of the operations of block 1530 may be performed by a virtual antenna manager as described with reference to FIGS. 10-11, or by a virtual antenna configuration component as described with reference to FIG. 11.

At block 1545, the wireless device 115 may determine a channel matrix for data demodulation during a channel estimation procedure interval. The channel matrix for data demodulation may be based at least in part on the mapping matrix. The operations of block 1545 may be performed according to the techniques described with reference to FIGS. 1-8. In certain examples, aspects of the operations of block 1545 may be performed by a virtual antenna manager as described with reference to FIGS. 10-11, or by a virtual antenna configuration component as described with reference to FIG. 11.

At block 1550, the wireless device 115 map the digitally sampled signal to a set of one or more virtual antenna ports. The mapping may be performed for one or more observation sets of digital samples of the signal. Each observation set may represent a window of sample time vectors. In some examples, the mapping may be based at least in part on mitigating the interference of the SoI. In some examples, the mapping may be based at least in part on the mapping matrix (e.g., on the computed values of the mapping matrix). In some examples, the mapping may include performing, for each observation set of digital samples of the signal, a linear convolution of the mapping matrix with the observation set. In some examples, the mapping may include setting, based at least in part on the mapping matrix, filter coefficients for a set of multi-tap digital filters; processing each observation set of digital samples of the signal through the set of multi-tap digital filters; and generating a set of digital samples for each of the one or more virtual antenna ports by summing, for each of the one or more virtual antenna ports, a set of outputs of a subset of the set of multi-tap digital filters. The operations of block 1550 may be performed according to the techniques described with reference to FIGS. 1-8. In certain examples, aspects of the operations of block 1550 may be performed by a virtual antenna manager as described with reference to FIGS. 10-11, or by a virtual antenna processing component as described with reference to FIG. 11.

At block 1555, the wireless device 115 may process an SoI by processing digital samples associated with the set of one or more virtual antenna ports. The operations of block 1555 may be performed according to the techniques described with reference to FIGS. 1-8. In certain examples, aspects of the operations of block 1555 may be performed by a signal processor as described with reference to FIGS. 10-11.

It should be noted that the methods described above describe possible implementations, and that the operations or steps of the method may be rearranged or otherwise modified such that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications network or system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving a signal using a plurality of radio frequency (RF) chains of a wireless device;
digitally sampling the signal over a period of time at outputs of the plurality of RF chains, the sampling resulting in a plurality of sample time vectors, each sample time vector including a plurality of digital samples corresponding to the plurality of RF chains for a sample time;
identifying an interference channel contributing to interference of a signal of interest (SoI);
mapping the digitally sampled signal to a set of one or more virtual antenna ports, the mapping being performed for one or more observation sets of digital samples of the signal, each observation set representing a window of sample time vectors, the mapping being based at least in part on mitigating the interference of the SoI; and
processing the SoI by processing digital samples associated with the set of one or more virtual antenna ports.

2. The method of claim 1, further comprising:
transmitting at least one signal using at least one RF chain of the wireless device,
wherein the interference channel is associated with the transmission of the at least one signal.

3. The method of claim 2, further comprising:
wherein the received signal is received according to a first RAT, and at least one transmitted signal is transmitted according to a second RAT.

4. The method of claim 2,
wherein the interference channel is based at least in part on: interference associated with at least one of duplexer and tuner impedance mismatch of the RF chains, non-linearity of transfer functions of power amplifiers in the RF chains, limited RF isolation between different RF chains, limited isolation between physical antennas associated with different RF chains, or a combination thereof.

5. The method of claim 1, further comprising:
determining a space-time covariance matrix for reception of the signal using the plurality of RF chains; and
determining a mapping matrix based at least in part on an eigenvalue decomposition (EVD) of the space-time covariance matrix, wherein the mapping is based at least in part on the mapping matrix.

6. The method of claim 5, further comprising:
computing values of the mapping matrix based at least in part on a set of smallest eigenvalues of the EVD, wherein the mapping is based at least in part on the computed values of the mapping matrix.

7. The method of claim 5, further comprising:
computing values of the mapping matrix based at least in part on the interference channel using a Gram-Schmidt orthonormalization procedure.

8. The method of claim 5, wherein the mapping comprises:
performing, for each observation set of digital samples of the signal, a linear convolution of the mapping matrix with the observation set.

9. The method of claim 5, wherein the mapping comprises:
setting, based at least in part on the mapping matrix, filter coefficients for a set of multi-tap digital filters;
processing each observation set of digital samples of the signal through the set of multi-tap digital filters; and
generating a set of digital samples for each of the one or more virtual antenna ports by summing, for each of the one or more virtual antenna ports, a set of outputs of a subset of the set of multi-tap digital filters.

10. The method of claim 5, further comprising:
adjusting the space-time covariance matrix for the signal, before determining the mapping matrix, by pre-multiplying the space-time covariance matrix by a square root matrix of a noise space-time covariance matrix for reception of the signal using the plurality of RF chains, to produce a product, and by post-multiplying the product by a Hermitian transpose of the square root matrix.

11. The method of claim 5, further comprising:
adjusting the space-time covariance matrix for the signal, before determining the mapping matrix, by subtracting a noise space-time covariance matrix for reception of the signal using the plurality of RF chains from the space-time covariance matrix.

12. The method of claim 5, wherein the space-time covariance matrix is determined during periods of idle mode reception at the wireless device.

13. The method of claim 5, further comprising:
determining a channel matrix for data demodulation during a channel estimation procedure interval, wherein the channel matrix for data demodulation is based at least in part on the mapping matrix.

14. The method of claim 1, wherein the set of one or more virtual antenna ports differs in number from a number of RF chains in the plurality of RF chains.

15. An apparatus for wireless communication, comprising:
means for receiving a signal using a plurality of radio frequency (RF) chains of a wireless device;
means for digitally sampling the signal over a period of time at outputs of the plurality of RF chains, the sampling resulting in a plurality of sample time vectors, each sample time vector including a plurality of digital samples corresponding to the plurality of RF chains for a sample time;
means for identifying an interference channel contributing to interference of a signal of interest (SoI;)
means for mapping the digitally sampled signal to a set of one or more virtual antenna ports, the mapping being performed for one or more observation sets of digital samples of the signal, each observation set representing a window of sample time vectors, the mapping is based at least in part on mitigating the interference of the SoI; and
means for processing the SoI by processing digital samples associated with the set of one or more virtual antenna ports.

16. An apparatus for wireless communication, in a system comprising:
a processor;
memory in electronic communication with the processor; and
instructions stored in the memory and operable, when executed by the processor, to cause the apparatus to:
receive a signal using a plurality of radio frequency (RF) chains of a wireless device;
digitally sample the signal over a period of time at outputs of the plurality of RF chains, the sampling resulting in a plurality of sample time vectors, each sample time vector including a plurality of digital samples corresponding to the plurality of RF chains for a sample time;
identify an interference channel contributing to interference of a signal of interest (SoI);
map the digitally sampled signal to a set of one or more virtual antenna ports, the mapping being performed for one or more observation sets of digital samples of the signal, each observation set representing a window of sample time vectors, the mapping is based at least in part on mitigating the interference of the SoI; and
process the SoI by processing digital samples associated with the set of one or more virtual antenna ports.

17. The apparatus of claim 16, wherein the instructions are further executable by the processor to cause the apparatus to:
transmit at least one signal using at least one RF chain of the wireless device,
wherein the interference channel is associated with the transmission of the at least one signal.

18. The apparatus of claim 17, wherein the received signal is received according to a first RAT, and at least one transmitted signal is transmitted according to a second RAT.

19. The apparatus of claim 17, wherein the interference channel is based at least in part on: interference associated with at least one of duplexer and tuner impedance mismatch of the RF chains, non-linearity of transfer functions of power amplifiers in the RF chains, limited RF isolation between different RF chains, limited isolation between physical antennas associated with different RF chains, or a combination thereof.

20. The apparatus of claim 16, wherein the instructions are further executable by the processor to cause the apparatus to:
determine a space-time covariance matrix for reception of the signal using the plurality of RF chains; and
determine a mapping matrix based at least in part on an eigenvalue decomposition (EVD) of the space-time covariance matrix,
wherein the mapping is based at least in part on the mapping matrix.
